(19) United States
(12) Patent Application Publication
(10) Pub. No.: US 2020/0160147 A1
(43) Pub. Date: May 21, 2020

(54) HUMAN BRAIN LIKE INTELLIGENT DECISION-MAKING MACHINE

(71) Applicant: NATIONAL INSTITUTE FOR MATERIALS SCIENCE, Ibaraki (JP)

(72) Inventors: Anirban BANDYOPADHYAY, Ibaraki (JP); Subrata GHOSH, Ibaraki (JP); Daisuke FUJITA, Ibaraki (JP)

(21) Appl. No.: 16/635,892

(22) PCT Filed: Aug. 2, 2018
(86) PCT No.: PCT/JP2018/028963

§ 371 Date: Jan. 31, 2020

(30) Foreign Application Priority Data
Aug. 2, 2017 (JP) 2017-150173

(51) Int. Cl. G06N 3/04; G06N 10/00; G06N 3/08; G06N 99/00

(52) U.S. Cl. CPC G06N 3/0418; G06N 99/007; G06N 3/08; G06N 10/00

(57) ABSTRACT

Artificial intelligence research is failing to produce true intelligence in spite of enormous resources. The reason is that programming is unavoidable for data processing and so there is no way to replace an user. In addition, because of data deluge problem, it is impossible to analyze all data as conventional information. Hardware inspired by prime metric is provided, where a metric of artificial intelligence is built in which unknown random events are linked as a changing geometric shape. All information is converted such that layered geometric shapes clocking in a pattern or event becomes unit of information, not insignificant bits. All complex events are considered as a single point to go ahead on building higher level geometric shapes as part of a time crystal following prime metric.

### TECHNICAL FIELD

This invention relates to a new kind of decision-making device wherein the conditions and the respective decisions are written in a loop. The self-assembly of such decision-condition elements is encoded in the periodic oscillations or rhythms or clocks, as geometric shapes. The present invention includes all fundamental operational modules of a brain like frequency fractal hardware. The essential features of this brain model are experimentally derived. The present invention uses Fractal tape instead of a Turing tape, so it is not a Turing machine. Consequently, the present invention proposes a new Information theory called Fractal Information Theory (FIT). The present invention includes the development of a new information processing language. Instead of an external user, a metric of primes is used that morphs events happening around and simulate the past, present and the future. This is the first decision-making machine that does not use reduction of choices, does not use logic gate, solves NP complete clique problem. It does not require power supply as it harvests noise.

### BACKGROUND ART

For less than a hundred years, there has been a global attempt to make decision-making machines far beyond the Turing machine used in day-to-day life. In fact Turing himself suggested machines that would operate beyond Turing's logical machines, just like von Neumann wanted unique computer architecture namely non-von Neumann. There was no concrete success. Hyper-Turing research field generated several unique machines over nearly a century. In almost all cases, within a decade it was shown that the proposed invention of “beyond Turing” machine is actually a Turing machine. This invention argues a Fractal tape wherein Turing machine does not work. The new class of machine would seek industry attention because in principle, Turing machine is key to every single machines of the world, an alternate to this machine which diametrically different could create “a distinct world of industry that is similarly worthy to the present world of industry” Potentials of this new tape are plenty. For example, there is no reduction of choices. Since “reduction” is strongly associated with power loss, to operate such a circuit built according to this invention does not lose power. In astrophysics, theoreticians used to have a space time metric, while doing complex math, students used to refer to the metric time to time and retrieve all essential data to solve planetary problems. Similarly for Artificial Intelligence the inventors introduce a new metric of primes. The idea is to hack nature and make a computer that can generate most patterns that we see in nature. Just like simple space time metric has predicted correctly incredible physical events rightly, the prime metric of artificial intelligence is conceived to invent entire information from a very little known about a system.

In our previous invention filed as a patent application “vertical parallel processor” and granted later (Patent Document 1), we have demonstrated how massively parallel processing occurs on a surface. The previous invention was novel because information was processed horizontally and the decisions were captured vertically. Thus, we could avoid physical interface issues during a 2D pattern based computing. There were several negative points in the previous inventions, which needed to be solved. First, for industrial production we need 3D architecture, scaling up using a 2D system is critical. Second, we need a geometric language that interprets the external world sensory information like visual images, auditory sounds touch etc. Most importantly, the same language should be used for the hardware development. The previous invention did not address the most incredible feature of a human brain. Brain is standalone, it has several modules, but, even C. elegans (Caenorhabditis elegans) like animals do incredible things using only 302 neurons. Therefore, a new machine engineering protocol was essential that could represent the core idea of a biological machine. This is a very important matter for the contemporary industry. At this moment several billions of USD is invested in making an artificial human brain. Blue brain project in EU has a budget of 2.4 billion USD. Obama Initiative in US is ˜3 billion USD. Even though initial claim was to construct an artificial human brain, currently the target has been reduced to self-assembly of columns. Google X project is another drive, plenty of attempts all over the world. The system that will make the first brain would control the system. In this invention we cover entire evolution of brain and neural network with nested cavity resonator model (nested=cavity inside a cavity inside a cavity). This invention considers brain made of 250 classes of cavities while every single other brains that will be made around year 2024 considers neuron as the only component in the brain's information processing. All brain-building projects believe “brain is a Turing machine”. This invention negates that theory completely. This invention also argues for a new kind of information theory that does not consider “bits”, it is replaced by a clocking geometry.

Image processing and intelligence development have been extremely popular in the industry, because it has applications from video games for kids to make smart interplanetary operational robots. It is a multibillion-dollar industry. From medicine to space applications the demands for robots are increasing and the making of complex signal processing with complete automation is increasing. Though the present invention covers complete sensory operations of humans, the invention is not limited to the replication (mimicry) of a part of the brain, rather sensory system, memory system operations, and everything has been taken into account. Most importantly, the construction of a new language is an important aspect of this invention. For the last half a century, the current industry used a fixed machine language for user to communicate with the hardware. The present invention deals with hardware of a very different kind. Therefore, a new language has been essential. Circular oscillation or periodic oscillation could generate geometric shapes and that correlation between geometry and the material property has been used to create a new machine language. Application of this language has been applied to sensors and motor control in the artificial brain. However, we foreseen that industrial application of this new language will not be limited to an artificial intelligence and decision-making unit. The applications would stretch far beyond, into the domain of sensors and motor control. Even we envision that existing machine language used in every sphere of day-to-day used machines could be replaced by the presently invented language.

The development of sensors in the last 80 years has followed particular engineering principles. While sensing a particular signal only its analogue intensity variation has been the key. Now, here two new inventions are made in the field of sensor technology. First, nested rhythm based accumulation of sensory data. Therefore, instead of intensity of a particular frequency signal, we concentrate on the relationship between different frequencies and capture that relationship. Earlier technologies used digital multilevel logic to classify a sensory signal; and the current industry follows this protocol. It means a string of information is created from sensory operation. When a fractal geometry captures signals, then, the intricate relationship between different frequencies are captured as is. This is because the entire artificial brain is made of hardware that could sustain any fractal geometry, add them, subtract them, expand them and disintegrate them as required. Second, fusion of multiple sensors into a complex higher-level sensor, which is carried out in an artificial hippocampus designed and formulated by the inventors of the present invention. Since the existing sensors have linearized data, as a result, when we integrate multiple sensory data for practical industrial application, it requires intelligence from outside to cook artificially. However, when sensory data contains fractal geometries, the rules of combining geometries with each other stay inside. Hence, we do not need to add external intelligence by imagination, what a system would be. Hence, we make a radical and fundamental shift in the processing of information, by changing our worldview from Turing to a Fractal tape.

Self-defragmentation of logical information stream is often applied in the existing computers. However, that is applicable to a linear stream of information only. A new defragmentation technology is introduced here that is specifically applicable to fractal like geometrical arrangement of information. In the existing field of artificial intelligence a higher level logic, deep learning, higher order logic, higher level perception, all critical features require human intelligence and all features could have a very different kinds of arguments. However, this is not true for fractal geometric structure of information. Here, the fractal geometric features of a particular sensory data come from nature, or external environment, therefore, not much independence. If external world changes the way fractal information is made, the internal hardware is designed to follow the path. Say, information is encoded as circles or rhythms. Then, no matter how they integrate, these rules are automatically extracted in the filters. This is the first radical shift from existing AI technologies. Secondly, the similarities in the nesting of circles are identified and those rules are also identified. Third, based on the higher level rules, sensory information is located at a particular place for faster perceptual integration. For this purpose automated defragmentation runs in the system perpetually. This particular feature was absent in the field of artificial intelligence and in the computer defragmentation that we do day to day. Spontaneous development of better search algorithm, identification of higher level perception rules therefore become integral feature of the system and these processes run without external instruction. Then, the development is not limited to editing the higher order arguments, it is also applied to the development of hardware. No matter how the hardware would change in course of time, even those learning protocols are incorporated into the system. This is also a new feature from previous brain building projects.

### SUMMARY OF INVENTION

### Technical Problem

The purpose of this invention is to design and develop essential operational modules for a human brain like computer following a generic route that operates by itself. The device if triggered externally by any form of electrical, magnetic, electromagnetic, mechanical or electromechanical sensory input, then the system starts processing. The system analyzes, converts signals into nested rhythms or circles whose pixels are made of resonant frequencies. Time crystal where phase is the only information for computing is biological. It was never used to build a computer. During self-assembly of clocks the development of a new decision-making geometric language and fractal tape based machines, sensors are an integral purpose of this invention. Finally, the application of the present invention exhaustively covers the technological development for the spontaneous evolution of higher order hardware management. The higher order logical management and development follows along with the hardware development.

### Solution to Problem

According to one aspect of the present invention, a computer made of cavity resonators is provided (It should be noted here that the cavity resonator may be replaced with a dielectric resonator to achieve the same results, and thus when “a cavity resonator” is mentioned throughout the present specification we can always use a dielectric resonator instead of the cavity resonator), wherein self-assembly of clocks made of frequency as points of a geometric shape, where the frequency cycle is also referred to as rhythm, learns inherent dynamics of input signals, by itself using a prime metric and responds to the query as rhythms spontaneously,

wherein, the user is replaced by a metric of primes, which includes all possible solutions if one gradually builds fractal cavity resonators, filling it with resonating wave, which is a fundamental device unit of this computer.
wherein resonating frequencies are written that represents basic geometric shapes, clocks run to make them an event, on the time cycles perimeter two or more cycles couple to integrate a problem and its solution in a single cycle, where the interconnected cycle is also referred to as nested rhythm, and if a cycle runs by resonant frequency activation, due to loop, the solution is spontaneously delivered,
wherein to increase the computing power or number of rhythms, smaller cavities are added inside a cavity, thus, keeping total volume constant, wherein there is no junction or wiring in the computer, components transfer energy by wireless resonant energy exchange,
wherein any given 2D pattern made of frequencies is filtered into a composition of cycles or clocks or elementary geometric patterns, which is memorized in the resonance chain and in case of match of cycles stored in the memory with the external input, the stored cyclic oscillations in the memory spontaneously activate, and since all information in computer is stored as interconnected rhythms, other linked cycles also activate as associative memory,
whereby reconstruction of nesting of cycles, which is pattern reconstruction, continues even in absence of computation, it never stops; thus, the computer learns the higher level perception rules by itself, stores and spontaneously reply back the transition pattern for any given input of unknown composition of 1D, 2D or 3D pattern of pulses, wherein, the sensors in the computer converts all problems or any form of input signals as nested cycles of frequencies and then tries to bring the nested rhythm stored inside the computer into a singularly operating cycle, in that process the problem is solved, wherein the process operates in following four steps: (a) input nested cycles or time crystal made of self-assembled clocks resonate with the nested rhythms stored inside; (b) the nested rhythm inside expands and various new cycles activate which is sent as feedback to input nested cycle, thus, query is crosschecked in a feedback loop; (c) higher level time cycles, which are slow rhythms, activate and trigger perception related cycles, which re-enters into feedback loop; and (d) spontaneously replying back to the questioner wirelessly, and the loop continues until a slow time cycle is born that integrates all local cycles thus produced into a single loop.
The computer may be arranged,
wherein each cavity has an upper and a lower frequency limits which follows a specifically defined clock speed, therefore the computer uses multiple clocks one inside another, and a question asked to a slow clock that syncs with output is sent to faster clocks inside. Therein the clock processes, finds the solution and the decision is then delivered to the upper layer much before the slow clock ticks even once further, wherein the cavities self-assemble following ordered factor metric (ordered factor metric=prime metric=a plot of number of factors calculated for an integer similar to the space-time metric used in astrophysics). The metric word is used to reflect similarity with the space time metric in astrophysics (metric word means distance, here a curve connects the factors of integers). In astrophysics the solutions of particle dynamics are derived from space time metric. Here, from the ordered factor metric or the prime metric, the information dynamics is derived. The ordered factor calculated from integers generate a 2D plot that delivers a wide ranges of information similar to the space time metric. Here is the process to generate the prime metric. The plot of ordered factor of integers is divided by 2 and the derived value is plotted across along the Y axis while the integers are plotted along the X axis. This is one form of ordered factor metric. Primes do not contribute but regulates the features of ordered factor metric, so ordered factor metric is called prime metric. The ordered factor is a number of distinct nested cycle composition, and the plot appears like various geometric shapes. Similar to space time metric during self-assembly geometric shapes morph following the prime metric. For self-assembly within a cavity and above on its boundary, the changing geometry varies from one structure to another,
wherein the prime metric acts as a real user, controller regulator of the entire hardware.
An user can set tasks to perform before the creation of the hardware, but once the prime metric based hardware is built, it takes over, as it searches for information or events outside in its environment and finds situations to respond,
wherein in the ordered factor metric several geometric loops drawn between any two primes reflects the energy back and forth. Thus it drives cycles or rhythms or clocks. A coupling of these loops have also generated the ordered factor metric. Thus, coupling of clocks makes nested circles or nested clocks or time crystals. Thus, the nested rhythm of time crystal complex is formed,
wherein a set of frequencies derived from the ordered factor metric is used to build a generic machine. During this conversion of the ordered factor into a composition of frequencies and their relative frequencies are plotted as multiple concentric circles made of frequencies. This is called frequency wheel, each fractal space of the computer hardware or even each component has its own frequency wheel and together they make a frequency wheel. A frequency wheel represents decision making machine's 2D information architecture. the 3D architecture would be a nested architecture of Bloch spheres
wherein by coupling loops found in the ordered factor metric derived complex frequency wheels and its corresponding nested rhythms or clocks are developed. The layers increase and the number of nested rhythms increases to increase the computing power. In other words, the number of clocking geometries is a measure of computing power,
whereby at any layer of the frequency wheel, the computer processes real time operation. However, all the rest associated processes of information with respect to the layer under consideration happens in imaginary time. Therein, all layers above and below the operating layer, actively changes the decision taken at any layer using various complex number (a real magnitude of amplitude of a frequency and phase), each representing the functions of a particular layer.
The computer may further be arranged,
wherein the cavity inside a cavity, which is referred to as nested cavity, arrangement eliminates noise in the transport of information where the information is nested rhythm or clocking Bloch sphere holding geometric shapes, and the rhythm is cycle of frequencies or a clock,
wherein any input pattern that is resolved into a set of cyclic vibrations or a clock holding a geometric shape whose each corner is represented by a frequency. Due to the existence of triple frequency bands, as a result of metric of primes, the nested rhythms or clocking Bloch spheres follow three steps to learn and evolve the internal nested rhythm for future problem solving: (i) compare nested rhythm or clocking Bloch sphere architecture inside which has already been learnt with the new incoming nested rhythm from outside, find the difference rhythms; (ii) add those difference rhythms to the main nested rhythm inside; and (iii) the added nested rhythms connect or reject more rhythms or cycles to stabilize the added network, this process continues even in absence of input,
wherein
(i) due to different operational frequencies, the same image (origin of an image could be visual, auditory, taste, smell or touch) is seen in different resolution at different layers, and all images are converted in terms of basic geometric shapes and nested cycles, from bottom to top the complex image is filtered into simpler geometries, which is the hierarchical network of perception in this computer;
(ii) the cycles of geometric shapes made of frequencies continue to include nested rhythms from different sensors and form combined nested rhythm and new basic patterns form, which is learning of the hardware;
(iii) questions and answers are written on a single cycle, and if the frequencies encoded as question are activated, then the cycle runs, and the frequencies representing answers run automatically, where no choice is rejected no logic gate, no switch is used during computing; and
(iv) due to the existence of the resonance chain, the input energy given at any point of the chain is distributed all over the chain, thus, the system spontaneously reply back the matching and thus the computer performs search for finding a particular information without executing a dedicated searching protocol as it is frequently done in the conventional computer.
The computer may still further be arranged,
wherein the cavity resonator structure is an organic or inorganic synthetic material like polymer or block copolymer, a bio-material, a composite material, etc.,
wherein molecular electromechanical resonators create cavities following a 12 step growth process replicating (mimicking) the human brain cavity resonator model wherein the cavities at the 8th layer change geometry the most and cavities at the 12th and 1 to 5th layer change the least during information processing, and each cavity is associated with a particular resonance band, the change in the dynamics of cavities is to fill up the resonance chain,
wherein to accommodate self-similarity between clocking cavity resonators of different layers, where the modeled 12 layers for human brain like computer, the complex number based functions are used to represent the clocking Bloch sphere. The complex functions representing the frequency amplitude and the phase with multiple generalized imaginary numbers represented as a clocking Bloch spheres operate reside side by side in this function,
wherein he power of computing depending on the density of the resonance states or the density of clocking Bloch sphere holding the geometric shapes (a Bloch sphere is a sphere of imaginary states all around, except at two poles, used in Quantum mechanics) and the total frequency bandwidth of the entire hardware.
The computer may still further be arranged,
wherein the computer consumes power for triggering the resonant oscillations in the cavity resonant oscillators, wherein
(i) the hardware consumes power in a self-similar way at all temporal and spatial scales, where 12 layers for brain like computer cause the power consumption of the process of triggering the resonant oscillations in the oscillators to be scale free;
(ii) the frequency wheel is made of a plurality of energy sources including ionic, photonic or electronic diffusion driven by available thermal energy kT (k is Boltzman constant, T is the absolute temperature of the environment) and other forms of noise that re-arranges itself continuously, and the cavities at different layers are designed to optimize motion path of electronic, photonic or ionic carriers; and
(iii) computing process does not require any specific power supply, and for triggering input, an external power is supplied at any point of the resonance chain and causes the power distribution not to concentrate at any point but to be homogeneously distributed all along the chain.

### Advantageous Effects of Invention

All these advantageous effects are summarized as below.

1. Memory and processor are the same element: ultimate application of homogeneity in the hardware design: memory storage & processing is the same event: One of the major challenge of an exascale computer (a billion billion calculations per second) is that a huge amount of data needs to be transferred from the memory space to the processors location in a very short time. Since the rotating circle or a clock holds a geometric shape as it runs, this is the memory. The rotation of the clock if runs more than one geometry in the clock is the processing. The computer has a singular space for the two key events known to perform computing. The computer has no bits, only crystals or jelly of clocks. Hence, the only element used is a clock, only parameter for information is phase. Topology of phase is information and various different kinds of mathematical topology could be created using a fractal tape. Computing is morphing a topological curvature.

2. The present invention enables us to create standalone robotic brain that does not require any programming. Using all possible solutions of cavity resonators a prime metric is calculated and the hardware is primarily an assembly of cavity resonators that generates the vibrational frequencies as described in the prime metric. Even if some parts of the hardware are missing, the network of time cycles or rhythms produce the missing clocking or frequencies. Prime metric could be plotted in various ways, each plot has its own distinct significance. Prime metric holds all possible pattern of resonant frequencies that can happen if one moves from the smallest to the largest dimension possible. Since it calculates the solutions based on symmetry not based on number of elements or length of time or amount of mass, it reflects all possible patterns that could happen in nature. So, one could state, that the computer is built to mimic everything that happens in nature. So, it estimates beforehand the possible course of events before it even takes place.

3. Computing power is not proportional to the physical space i.e the number of processing elements: In the present invention the required space does not increase exponentially with the computing power: A cavity resonator's boundary layer is enough to generate & process information. Also computing power depends on the density of resonance frequencies per unit time domain, which is not a function of space, but composition of symmetry. Continuous filling up cavity inside until atomic scale enables packing astronomically more clocks. Not just that a time crystal can hold several geometric information to be viewed distinctly from different directions. Hence a single time crystal could hold large number of geometric shapes in a fixed space. Addition of resource has no value if it does not add to symmetry.

4. No input is required, it morphs to emulate external signal: The present invention relates to a typical sensor design protocol that enables to capture the hidden intelligence of the system. Since the hardware uses prime metric, it captures the hidden dynamics of a system via hierarchical nested rhythms or self-assembled architecture of clocks: Since we use prime metric, even if sufficient information is not available, it simulates the missing part. One does not have to acquire input, all possible geometries are already inside. The hardwire (self-assembled architecture of clocks) inside the computer of current invention only has to reconfigure itself to emulate the most similar dynamics found in nature or in its environment. As it frequently happens in a conventional computer, one to many communications are not disrupted if one of the elements of the assembly stops functioning. The participating components are never linearized and rebuilt using models.

5. Computing speed has no meaning in these kind of fractal time hardware. Total time of computation is fixed by the slowest clock used for encoding the conditions of a problem. In normal computers, the computing steps are spatially and temporarily linear or non-linear. More is the complexity, more is the time or resources required to solve the problem. Here, fractal time is used. Means a problem if uses a one second clock, it hold all information inside, in the microseconds clock, some information in nanoseconds clock and some information in the picoseconds clock. Hence, the problems are solved in one seconds only. More time is given, better is the resolution of the problem. The present invention relates to a device that uses a new class of geometric language. The advantage of this language is that it uses materials property to write events. Halting is naturally encoded in the circle in the natural process of loopmaking: A circle makes sure that a composition of nested rhythm does not trigger everything in the brain. If all rhythms are triggered as a natural process, then no decision could be taken. Halting problem is one of the fundamental problems in the computer science; predicting halting is a critical problem.

6. The present invention relates to a device which could replicate the intelligence of any biological machines. A generic frequency fractal machine construction protocol has been developed. Uploading the information architecture of the major part of the brain & biological organs into an artificial robotic organs: Using existing scientific protocols, one has to die first to live forever. However, slice it, map it to fix or remake it may not work. Uploading brain atom by atom cannot upload their collective dynamics, brain's information lies in the emergent dynamics of the individual components. The emergent dynamics means the properties generated by the spatial arrangement of the components, not due to the We can put atoms right, but not its motion as neighbors do contribute to that. Hence the resonance chain based self-assembly jelly like organic molecules to upload human brain's nested cycles is the only possible way. Information architecture holds the dynamics, that dynamic could sync with the atom by atom replica of a brain. Therefore, if we can map the nested rhythms, following a human for a certain number of years, would create a replica and that circuit would continuously follow & update as the human lives, when he undergoes a natural/accidental death, his replica could take over.

7. In the present invention, search to find is not essential: Perception capture: Searching information in a massive data is difficult in big data problem. “Spontaneous reply” does not require searching. In addition, we do “perception capture”, it means, after the external signal converted to nested rhythm, it expands, the primary expansion data is sent back as output and if there is a match then more expansion on matched information is carried out. Coupled resonance chain transfer energy, circuit is not essential: We do not need circuit because it is a cavity inside a cavity inside a cavity.

8. No power supply, zero heat loss: During processing, only essential elements respond, wirelessly, in absence of circuit. Most importantly, since we do not reduce any number of choices no junction exists in the entire computer, there is no heat loss, a critical obstacle to miniaturization is resolved here. Since reduction by rejection is replaced by spontaneous activation, all associated paths simultaneously coexist. Additional routes are used in “perception capture”, or “hierarchical learning”. Entire hardware is based on wireless communication, even if wiring is made at the large scale, the topology of wires play an active role in information processing. Noise and thermal energy harvesting is an essential feature of the hardware to assist screening effect free wireless communication.

9. Every component in the artificial brain like machine is life like: The construction of prime metric is what nature follows. This hardware's similarity with nature enables it to learn from nature with a purpose. We do not use this computer, for a given purpose, the computer uses nature. Neither the computation is parallel nor sequential, it is simultaneous everywhere. Fractal clock network makes it possible.

10. Ten situations where one could use this computer: (i) Information is not sufficient or organized to frame logic; (ii) No time is available to find the rules for structuring logic, i.e. the urge for an instant reply; (iii) Rejection of choices is not advisable. The rejected choices could take over the lead anytime as the dominant player; (iv) Database is too big to structure it into a format solvable by a futuristic quantum computer. It requires to “search” without searching, i.e. spontaneous reply; (v) The decision-making devices of the future cannot carry a giant megawatt power supply continuously. Thermal & electrical noises are the only energy sources; (vi) We encounter a system that uses an unknown language, cannot be understood at all; (vii) Learning the real parameters, using which a system configures its response. Complete rejection of black box approach, to unraveling the true dynamics; (viii) A large number of parameters are being born, disappear, change and redefine itself with a truly random, chaotic fashion. When, even the variable parameters could not be identified; (ix) Undefinable factors govern a situation. A factor has several sub-factors. In addition, each of those has several sub-sub-factors. Thus, the logical statements inside logic inside logic perpetuate into an endless network; (x) Computing is always a reduction of choices, but in morphing, it is just the opposite. There is a continuous increment of choices, and that defines non-computing. Output is more than input.

### BRIEF DESCRIPTION OF DRAWINGS

FIG. 1 A drawing describing a typical decision making device of the present invention (artificial brain) and its different operational modules.

FIG. 2 A drawing showing operational steps of the artificial brain.

FIG. 3 A drawing describing the non-Turing Fractal tape that makes the basic decision making device for constructing the artificial brain. Here, one could see one tape at the top. The tape has many cells that can take decision. The cells could represent a clocking fractal cavity resonator that is used to build the artificial computer, or a neuron or could be a protein. Each cell in the fractal tape network has a tape inside. This tape-cell architecture is the basic decision making machine. Existing computers use a linear array of cells, but this structure does not.

FIG. 4 (401) A drawing of waveforms that could be created in a cavity resonator. A particular case of six waveforms is shown here. Six waveforms could arrange three possible ways. (402) A drawing showing eight compositions of 12 waveforms that could be created in a cavity resonator. (403) A plot for the number of waveform compositions with the number of waveforms residing in a cavity. One possible fractal formation is demonstrated here. The fractal tape looks like a tear drop. It could be plotted as a single unit or side by side, when it is plotted side by side (bottom most panel), it is said, “resonance chain”. The pattern of solutions is prime metric.

FIG. 5 A drawing showing nine different ways of creating a prime metric. The resonance frequencies generated from the cavity resonators is arranged in various ways. Depending on the typical parameters taken into consideration various different kinds of grouping between the frequencies occur. These are noted here.

FIG. 6 A drawing showing a unit decision making device, it has many clocks in its time crystal. The device is a cavity resonator and four waveforms making the resonance bands of this device are shown. By using 6-8 peaks (402 in FIG. 4), or eight dots in a circular area, the time crystal could be represented as simple area or frequency wheel, this wheel is called frequency fractal. It is also shown as circular motion of a system point making clocks or rhythms.

FIG. 7 A drawing showing extension part of FIG. 6. A time crystal (FIG. 5) for triplet of triplet of octave is represented as 3-3-8 and it is the fundamental unit for evolving the decision making device. Four columns are plotted side by side. In the drawing, the first (leftmost) column shows the circular dot representation of frequency fractal, the second column shows wheel presentation of the same, third column shows circular oscillations representing the frequency fractal, and the fourth (rightmost) column shows biomaterials equivalent complexity to the frequency fractal.

FIG. 8 A drawing showing the frequency fractal of a brain like decision making machine. Triplet of triplet is explained and 12 bands of the human brain is shown, in the L=8 system (top right corner next to the real human brain image) its two possible rhythm architectures (R=137) are noted.

FIG. 9 A drawing describing the construction of a frequency fractal of a human brain with all 12 bands with different carriers and group of frequencies.

FIG. 10 A drawing describing the frequency fractal or time crystal of a human brain with all 12 bands with different carriers and group of frequencies.

FIG. 11 A drawing showing three plots for the human brain side by side. From left to right, the drawing in the extreme left shows a life cycle rhythms how old cells are replaced. In the middle the same frequency fractal as those described in FIG. 9 and finally to the extreme right, a drawing of nested circles or rhythms or time crystals 2D picture, representing the human brain.

FIG. 12 A drawing showing the classical computing search and find process. In the present invention, there is spontaneous reply, no need to search.

FIG. 13 A drawing showing clock inside a clock inside a clock principle of time and space management in the present invention. To the right, how nested circles are automatically filtered into different layers is shown.

FIG. 14 A drawing showing ID, 2D and 3D signal filtering protocols in the sensors attached to the present invention. A drawing showing experimental data for speech converted into nested circle or nested rhythm conversion. This is a multilayer decomposition of the speech signal.

FIG. 15 Resonance chain of a time crystal filters out each clocks and those domains with nearest match with the clocking geometry activates. Thus, entire time crystal holding an event is sensed.

FIG. 16 All time crystals are connected to a slower clock. Activation of the singular clock at the lowest level, that is the fastest time cycle, triggers slower clocks and that clock may trigger a path connecting the faster clocks. Thus, higher level decision making is shown here.

FIG. 17 A drawing showing elementary decision making process of the computer, in which input situations and the output solutions are all written on a circle. This is a drawing explaining an automated halting protocol. Local activated nested rhythms during a decision making process form a loop. Whenever new clocks holding a geometric shape appears, all the participating geometric shapes become part of a new circle or clock. When a system point completes a closed loop, it delivers a fixed solution, thus the system halts by itself.

FIG. 18 (section 1801) A drawing showing that Learnt nested rhythm residing inside the brain like decision making machine and the new incoming nested rhythm is spontaneously compared and the new nested rhythm is detected (“difference”). (section 1802) A drawing showing that the “difference” nested rhythm of the previous figure section (section 1801) is connected to the internal nested rhythm as a part of the learning process. (section 1803) A drawing showing that once the learning as described in the previous figure section (section 1802) completes, all learnt nested rhythms start creating new loops as part of hierarchical learning.

FIG. 19 A drawing showing that multiple sensor (e.g. visual, auditory) generated nested rhythms from input signals are added together before processing.

FIG. 20 A drawing showing experimental data. PCMS based synthesis of time crystals.

FIG. 21 A drawing showing experimental data, specifically fractal network of time crystals.

FIG. 22 A drawing showing experimental data summary, specifically fusion of time crystals.

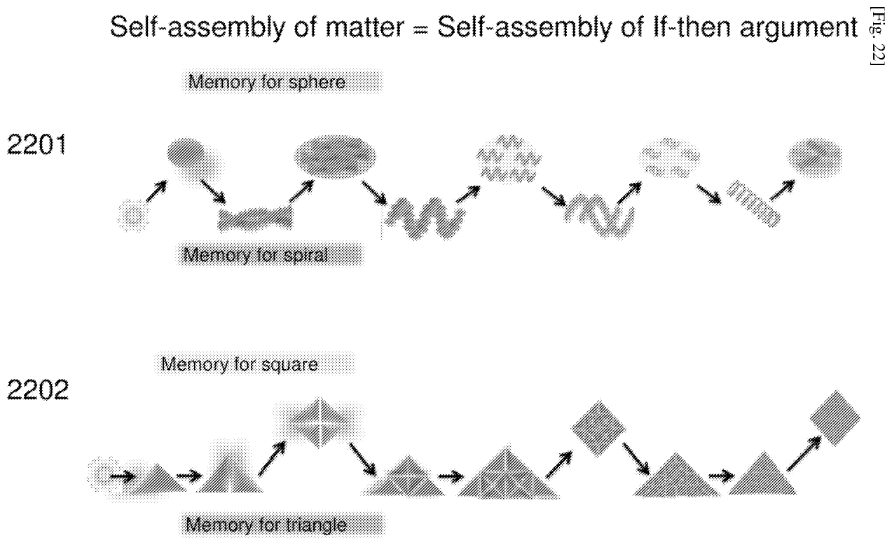

FIG. 23 A drawing showing experimental data specifically transformation of clocking.

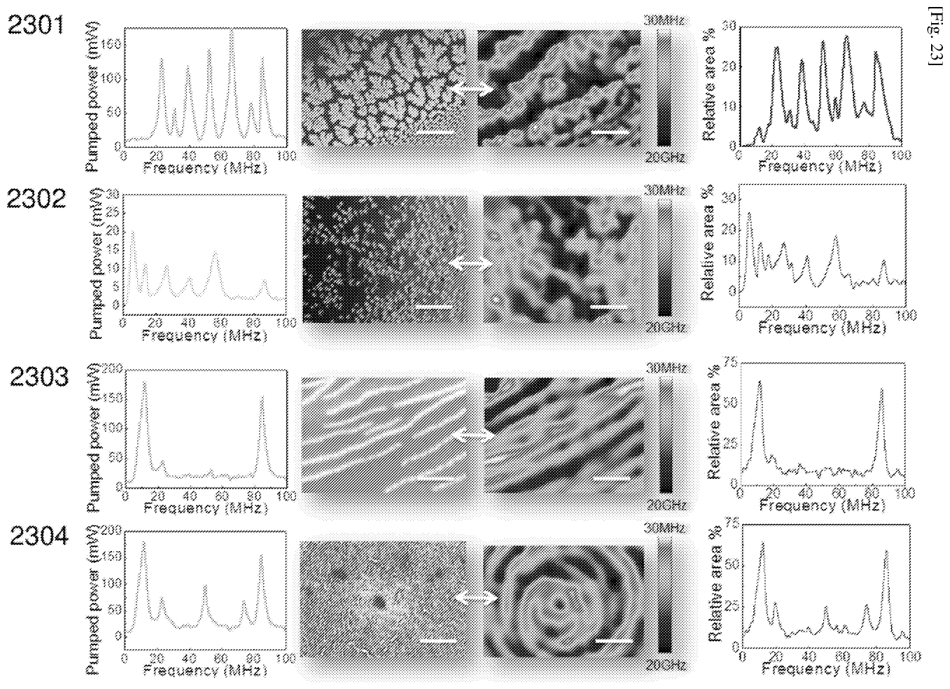

FIG. 24 A drawing showing experimental data specifically formation of organic jelly made of time crystals.

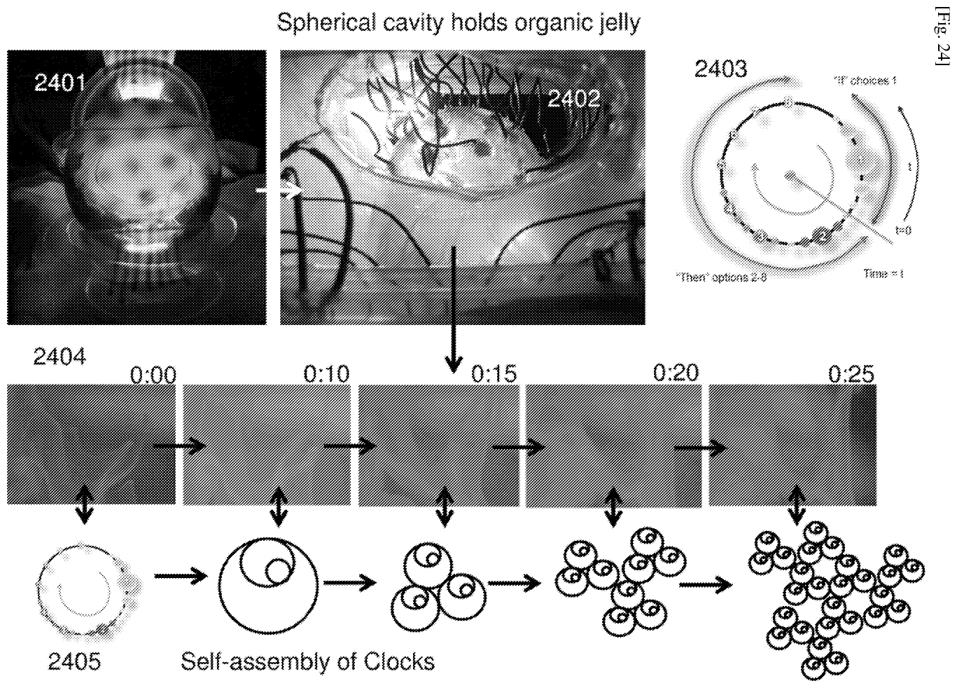

### DESCRIPTION OF EMBODIMENTS

We now explain the present invention in detail in correspondence to the claims.

<Description of the Features According to Claim 1>

The present invention relates to a new kind of computer that is not a Turing machine that converts every single piece of information in the universe as a linear sequence of events. The computer follows fractal tape that uses undefined states to make decisions, which was hitherto considered impossible to use. One important aspect of Claim 1 is that there is no user for this computer. During construction of hardware one could set fundamentals of learning for this hardware. Once set, the hardware uses metric of primes to reconfigure itself. This metric of primes ensure (i) no software is required, (ii) missing events are simulated (iii) harvested energy from noise is directed via resonance chain to all cavities in a scale free manner.

The first claim outlines technical protocols for building a prime metric in the hardware. It is to be made clear that the present invention relates to building hardware. That hardware would have a structure that would vibrate with various resonance frequencies. For each frequency the resonating waveforms could arrange in various different ways. The number of choices makes a pattern. The pattern is called metric of primes.

For a century, several space time metric has been proposed. The present invention relates to a metric of prime that covers all possible solutions of resonance in a generic cavity resonator. If one systematically changes the cavity dimensions at any spatial range, adding one more waveforms at a time, the resonance frequencies of the derived devices would exhibit prime metric. Therefore, to experimentally realize a prime metric, one has to set dimension range, upper and a lower length limits. Then, within the range, set resonance carriers that would determine maximum wavelength to be used. Finally, fill with cavities with wavelength/integer. Therefore, the present invention of prime metric is not a hypothetical theoretical proposal, but a fully experimentally realizable model system.

The first claim has seven parts. First part outlines construction of ten types of prime metrics. Each type is derived from the same ordered factor of an integer data, but plotted in different ways. These ten types are designed to unravel detailed instructions to follow to build the hardware.

Type 1. First, C2 symmetry is considered. For C2 symmetry, ordered factor or OF (ordered factor) of an integer is divided by 2, and ±OF/2 points (±Y axis) are plotted against integer value along the X axis. Then, connecting the nearest neighbor OFs or solutions give 50% of all shapes favored by cavity resonators. In this way, one could make C3 symmetry (16%), and C5 symmetry etc for all symmetries related to primes.

Type 2. Plotting the same solutions in a polar arrangement unravels whether to arrange cavities helically clockwise or anti-clockwise.

Type 3. The integer, phase and ordered factor, these three values are normalized and plotted in a triangle to find the quantized phase. For a given range of integers, the quantized phase suggests background phase modulation by the hardware.

Type 4. Solutions or ordered factors are specially selected that are greater in number than the integer itself (ordered factor >=integer). This type of metric intricately maps specific unpredictable features to be added to the triplet of triplet pattern often observed in the metric.

Type 5. For ordered factor=integer, one could observe a unique fractal pattern observed throughout the entire number system. Three closed loops appear and the smallest loop contains three loops inside. This is said, triplet of triplet fractal. It means a cavity resonator following this metric would have three prime resonance band. Each band will have three bands inside.

Type 6. The ordered factors of integers if normalized reveals an oscillatory ripples made by primes. The ripples suggest natural clocking behavior to emerge in the cavities if the cavity size is chosen properly.

Type 7. As the integer value increases the slope of the ordered factor with respect to the zero point increases towards 90°. A triangle converts to a straight line for C2 symmetry plot. If the ordered factor-integer plot is made for c37 symmetry (ordered factor is divided by 37, and divided into 36 planes, each separated by 10°, then, one observes transition of a cone into a circular disk. Thus, it is a morphogenesis embedded in the metric prime.

Type 8. In the polar plot of ordered factor metric with integer, if one connects the points representing ordered factor with a line, it would reveal empty spaces. These empty spaces are not random. They make circles, at logarithmic separation. This is the origin of geometric identity, e²+phi²=pi². Phi represents golden ratio. Spontaneously generated topological constraint regulates, when to assemble cavities following golden ratio, when spirally and when it reaches equilibrium or circular assembly takes place.

Type 9. The ripples created by each prime generate unique patterns. However, the primes at the starting of integer series govern statistically all the patterns in the entire system. 50% of everything created in the universe would have C2 symmetry. 16% would follow C3 symmetry. This is why prime metric dominates in triplet of triplet symmetry. However, if one calculates C2 to C37, the first 12 primes cover 99% of all possible patterns in the metric of primes. Similarly, 2×3×5×7×11×13×17×19×23×29×31×37˜10¹¹. Approximately 10¹¹ number of oscillators if assembled using prime metric would generate 99% of all patterns possible. If one wants to grow further, one should make a unit cell made of 10¹¹ oscillators, and then start counting. These two plots are not metric by itself, but sets the limitations of the metric in device construction.

Type 10. There is a convergence in the ripples of ordered factor-integer plot, if the plot is not normalized. The convergence of ripples to the base line where primes exist is important. Clocking regulated by particular primes cannot regulate perpetually, if not coupled with the clocks regulated by higher primes. It ensures finite types of patterns to cover the entire metric space.

The First claim notifies protocols to build a circuit of clocking cavity resonators. Every integer gets a physical significance in the prime metric. An integer associates itself with a pair of ordered factor ±OF/2 values in the metric. The line connecting positive and negative points are solutions of a imaginary Bloch sphere, frequently used in quantum mechanics. Our consideration is logical as the surface of the Bloch sphere represents all possible paths using which all possible distinct clock assemblies could form in a cavity made of a given number of waveforms. An integer represents a unique quantum like oscillator that has no dimension like photon yet holds a particular number of waveforms along the perimeter of a circle. It is a nested clock. This physical significance enables one to use a mere mathematical plot as a source file to synthesize hardware.

The starting input to build this computer hardware is only a few integers and an incubator. The starting integers are locations to be bridged in the prime metric. The incubator decides the starting time scale as it sets the fundamental wavelength of a resonating wave. The synthesis of this computer hardware begins at a particular time scale set by the incubator dimension. Every integer sets a fundamental frequency and its harmonics. A set of integers would try to create their distinct series of harmonics. They would interact following prime metric. The missing parts in the prime metric need to be recreated to bridge the gaps between the minimum and maximum integers in a given input set. For example, say {2, 3, 8, 4032, 4098, 120006, 50007} integers are given to build computer hardware and a circular cavity of a particular space. Resonating standing wave of all associated shapes related to these integers fits the cavity. The vibrating membrane initiates the bridging of the discrete numbers. Not all, but minimum number of integers are essential to connect given integers by shape. Thus, between 2 and 50007, several new integers or Bloch spheres are born.

In the first claim, a protocol having the following three steps is outlined for bridging the numbers.

First step is to find if some of the given numbers are part of a particular shape already available in the OF-integer plot (mostly referred as prime metric). For any given shape in a prime metric, only a few integers create the main curve of a shape generated by closest neighbors in the prime metric. All input integers together distribute phase to complete 360°. Even integers inside a typical loop located in prime metric make 360°. Even an integer makes 360°. Therefore, all nesting group of clocks are identified.

Second step is to use prime metric to find ten structural features of all groups by drawing ten prime of metric plots described above. In this step, first task is to find groups of clocks that are connected by various ways. (a) Some clocking resonator components make a group that makes a convergent fractal geometric series. (b) Some components need to be repeated, and the design following which needs to be repeated. (c) There are several triplet of integers series with a very high OF values, ranging from 10s or 100s to infinity. These three factors are determined using prime metric first. Then, the second task is to (d) find global time and spatial symmetry in all directions. (e) Also, the oscillatory and damping relations are determined between different periods of component arrangement. (f) the geometry of empty space left vacant by components. These three global features distinctly make a list of guest and host clocking integers. Most importantly, which missing integers are needed to be taken into consideration is determined. The third task is to find (g) typical features of the local boundaries, which helps in (h) determining the accurate cavity shape. Thus, after eight tasks one determines between two limiting integers, the exact shape and overlapping boundaries of all cavities or clocking resonators. Note that a given simple set of integers have now expanded into a large set of integers. This is a clear expansion of codes. In the fourth and the last step, the (i) quantized phase used by clocking resonators is determined so that overlapping boundaries are resolved into spiral assemblies, following (j) clockwise or anti-clockwise rotation. Thus, ten prime metric plots are followed in a particular sequence to find detailed architecture of the clock assembly. Note that the limiting integers cannot set a strict boundary. During continuous learning, new clocks are born, which edit the limits, expand them based on the metric of primes in the same manner.

The third and final step is to arrange the clocking resonators following a few fundamental principles. (a) There should be only one slowest clock as a Bloch sphere. All other clocks would be its guests. (b) Two types of fractal features to be applied simultaneously should be arranged side by side and one inside another. (c) The fastest clocks are normally the smallest, they start the synthesis of entire prime metric hardware. (d) Self-assembly of clocks and wireless self-assembly of clocking cavity resonators run side by side in the incubator. The hardware needs to be supplied with additional materials, autonomously or manually. (e) Continuously the vibrational features of the hardware are monitored. The first claim outlines ten parameters that needs to be read perpetually to keep a track on its construction and post construction evolution.

The first claim outlines ten fundamental vibrational features of a generic hardware that is constructed following the metric of primes. The health parameters of a prime of metric hardware are the following.

One of the primary feature of a prime metric hardware is self-similar vibration. It means the plot of intensity vs frequency over its entire operational range would show superposition of various fractal like features. The nested Bloch sphere presentation is the complete information structure. It could be converted into an intensity-frequency plot. But not the other way round. While self-similar feature is abundant in an intensity-frequency plot, the creation of a temporary clocking network is abundant in the Bloch sphere representation. These temporary clock networks are local unstable set of periodic oscillations that helps the input to create missing integers described above. The necessity of temporary clocks disappears after the missing integers are replaced. When two neighboring integers in a given input code to construct hardware finds a large gap of integers between them, they make simplest clock to get integrated. If new clocking components arrive in the incubator, they vibrate according to the prime metric and create the right clocks needed to bridge the distantly located integers. Thus, several post generations of clocking network is born, until all of them are replaced by true clocking network representing the right integers. The redundant clocks disappear. The creation of temporary clocking network and spontaneous reduction of redundant clocks deliver unique features. It replaces the necessity of software, helps in retrieving a lost hardware, shrink data, autocorrect errors in information, generates limitless time cycles, sets halt condition in computing even before it begins.

<Description of the Features According to Claim 2>

The prime metric driven self-assembled clocks are all converted into a time crystal architecture. Time crystal means just like spatial crystal, it has different speeds of time flow at different intervals of a single period. It is generally considered that time is maintained by photon with the speed of light. The inventors have kept two options for editing time flow. First, the speed of carriers that maintains time flow in cavity resonators. This speed is slow, edited by local traps, temporarily. The main carriers continue to their cyclic flow. Now, the carriers could be electron, photon, ions, any form of energy packets or materials. The local clocks are called nested guest with the host. At least one guest is essential to make a primitive time crystal.

Existing computers use switch or oscillators to make circuits. In the present invention, the computer's basic information is kept by interlaced clock. Topology of clock assembly holds the key information. Topology is created by phase variation. How phase changes when one resonant frequency changes to another in a device is the key parameter that provides experimental data to construct the Bloch sphere architecture.

The most important aspect of the present invention is the use of singularity. Experimentally, the above noted trap of carriers that slows down or speeds up the time flow is the singularity point. A singularity means an undefined point. When the trap holds a clock inside, wherein suitable carriers run a loop periodically, it is defined. But on its perimeter, one may find traps once again. This journey of finding traps is a singularity, if the journey runs for many times. At the top layer, where the carriers trap for the first time, singularity is bridged by inner clocks. This is similar to renormalization. However, the present invention is interested in the relative position of traps or singularities on a closed loop. Unlike Feynman diagram, here topological map of singularity points hold the information.

Integrated information architecture is built from a prime metric because both integer and its ordered factor represent physical real world factors. An integer is not just a number, it is a circular path with a guest circle on its perimeter. An integer 5 means, 5 guest circles could exactly pack on its perimeter. This is purely a classical structure. The ordered factor of an integer cannot be represented physically using a classical 2D structure like an integer. On the nested circle picture of an integer we can connect two or more circles and still complete the circle. The number of ways one can do it is the ordered factor. Most importantly, all possible ways co-exist together, just like quantum. For integer 12, ordered factor 8 means, 8 disks, each 45° apart, can arrange to make 360, a sphere. Now, to keep the identity of each disk, we keep the poles on the great circle of the sphere. The sphere rotates around the great circles, touching 8 corners of the disks one by one. Eight points on the great circle are maximum possible singularities in this system. One gets the integer, here 12 by traversing one of the eight disk perimeters. All eight disks have 12 or less circles one after another. Each of these circles cross the disk at two points. A system point can move along the surface of the sphere connecting the cross points. An astronomically large number of such paths could be created. This is a Bloch sphere like structure like quantum mechanics, but with a few fundamental differences.

The differences from quantum technologies originate from a new type of Bloch sphere. In this new information theory, the Bloch sphere is fundamentally different. (i) There is no classical pole, or classical point. (ii) The number of superposition states is not 2, here it depends on the ordered factor of an integer. The number of ordered factor is the number of disk making the sphere. (iii) Disks of superposition and the integral circles on its perimeter make a grid for system point to travel through multiple paths. (iv) Product of an integer and its ordered factor is the number of circles on the sphere where singularity could happen. These circular areas on the spheres can hold new Bloch spheres. (v) The corners of geometric shapes are written in the circles on the discs. The resolution of writing a geometric shape depends on the number of circles on the spherical surface. (vi) Initially all discs are separated by a fixed angle. However, when these circles on the sphere get filled with clocks inside then, times or diameter of the guest clock is adjusted. This step changes the angular separation between the discs. (vii) The geometric phase of quantum mechanics changes only one parameter when a clock runs through a loop. Here, the evolution of geometric phase changes all the clocks inside the singularity points. (viii) In quantum, Bloch spheres do not self-assemble, while the Bloch spheres self-assemble in this new information theory. The self-assembly is controlled by prime metric. This self-assembly is not the self-assembly we know. Here two Bloch spheres do not come and fuse, one of them spontaneously grow on another. (ix) Two classical points sustain simultaneously in quantum. Here, several rates of time flow co-exist simultaneously. In quantum, one geometric phase is counted, here, different clocks count their parts simultaneously in a period. (x) Relative phase of several clocks is important. If not maintained, the geometric shapes hold by Bloch sphere changes dramatically. Phase change is a mode of editing stored information.

Claim 2 accounts information architecture as nested clocks or time crystal.

<Description of the Features According to Claim 3>

Claim 3 details how a single hardware made of prime metric could be used in four different ways to carry out four fundamental operations in a computer. All the clocks in the prime metric hardware do not run perpetually. The clocks holding the fastest and the slowest time domains run perpetually. The central time domain remains nearly static. In the central time domain, the number of clocks are much more than the essential number of clocks required to main the continuous chain of vibrations from the fastest to the slowest clocks. The computer switches to a nearly non-operative state if the chain of vibrations (resonance chain) delinks. If the continuity is not retrieved, the computer is fully non-operational. So, a few clocks are integrated suitably in the hardware for arranging the alternate resources to maintain a continuous chain of vibrations from the fastest to the slowest clocks.

As noted above, in the central time domain, there are much more number of clocks than essential to keep the continuity. The purpose is for holding wide ranges of memories and carrying out selective processing. If the fastest clocking domain and the slowest clocking domain represent two poles of a sphere, the central clocking domain represents infinite possible paths connecting the poles, passing through the spherical surface.

The prime metric hardware described in Claim 1 is a time crystal architecture such as described in Claim 2. Each clocking cavity resonator holds a geometric shape, but the clocks in the fastest domain are run by energy packets while in the slowest domain it is merely mechanical vibrations. Thus, in the central domain where the clocks use materials as carriers are most important as they change configurations to edit the singularity points to eventually edit the geometric shapes.

The first prime metric modules perform task to convert streams of signals into a time crystal. The process is noted as part of Claim 1 and Claim 2. This feature is common to all four modules. Mostly, the central time domain of the resonance chain is used to build the sensory module. Time crystal synthesis feature is fundamental to all four modules, but a special isolated module is kept connected to the sensors that produce complex stream of pulses. Clocks of this module run only when sensors trigger them.

The second prime metric module does not run its clocks always. A time crystal is in a nearly spherical structure; it does not have any direction, or has all directions. Directional use means that giving an input in the central time domain. This input activates a set of clocks back and forth towards the faster and the slower time scales. Direction means towards faster and slower time scale. Since a massive amount of geometric information is converted into a fractal seed with only a few geometries, only a few clocks are used to store that information. Computer hardware should spontaneously shrink a tree of information into a fractal seed, and expand that fractal seed into a full tree of information.

At the first step the entire hardware module emulates the time crystal input as is inside. Then, in the absorbed and recreated time crystal, all the repeating geometries are connected by a set of clocks. Hence, one gets configuration of a path. This path is the rule to repeat the elementary geometry. Initially, the elementary geometry is repeated everywhere on the path. Then, the clocks representing the basic repeating geometry is kept running at only one point on the path made of clocks. This typical location is chosen so that, if the clocks on the path start running along with the basic pattern, it regenerates the entire information. The creation of clocks following the geometric path is a processing of shrinking, and triggering to run the clock to regenerate information is an expansion.

The third prime metric module runs its crystal clocks always. It holds decisions as an associated chain of seed clocks. In the conventional computer, a system point searches the hardware and memory for information. Here it is just the opposite. The activated seed clocks of the third module (processor), searches for its seeds outside. If there is a match, the signal amplifies. The amplified oscillation is essential. However, since most of the clocks run by noise, thus an amplified signal remains undetected by neighboring clocks.

There is a fourth module whose clocks also remain silent always. However, only those clocks which are unfound in the processor module, or the missing clocks of an input are created in the fourth module. These new clocks are stored for a more rigorous search and embedding eventually into the processor at the right location.

<Description of the Features According to Claim 4>

Claim 4 outlines the process by which the prime metric hardware performs the task of processing information as an alternative to programming. Unlike conventional computers where a unit of information is a number with no physical significance, the geometric shapes are not kept alone in the present invention; they are clocked with the associated geometries, related to all kinds of sensory information. Thus, it is an event that is stored as a unit of information. Events self-assemble to integrate, edit, and even expand into domains that were never given as an input.

The prime metric bridges the missing vibrational links as pointed out in explaining Claim 1 and Claim 2. Even if no associations are found for a time crystal representing a set of discrete events, the prime metric bridges the gap in the frequency values by initiating the creation of new clocks. The dual operations by triggering the associative clocks and bridging the gaps anywhere in the frequency scale by prime metric ensure the creation of a temporary time crystal associating all the four modules.

As noted in Claim 3, sensor module clocks are activated by sensors; initiator module or bipolarity filter module clocks exhibit a kind of oscillatory activations; the processor module is always active; and the fourth module, the regulator module is a difference clock activator, or a negative activator. These modules are not independent. Claim 4 outlines the route by which four modules build a temporary time crystal that emerges to synchronize the distinct time crystals built in the four modules. This time crystal disappears as the four modules absorb the new input crystals. Therefore, four modules edit their own time crystals to neutralize the temporary time crystals produced in the system. These time crystals are equivalent to programming of a conventional vonNeumann computer.

Claim 4 makes a special note that the language used by the computer of the present invention is also unique. In the conventional computer, the machine language is abstract. Here, a consistent and systematic protocol is used in defining every single parameter. One key aspect to it is that a network of phase is used to define mass, space and time. As a result, every single physical phenomenon could be represented in terms of phase shift. It also means that complex equations and theories could also have a specific topological feature in the time crystals produced. A one-to-one correspondence enables the computer to process every single event and knowledge in the universe using a universal, geometric musical language (GML).

<Description of the Features According to Claim 5>

Claim 5 details about the driving forces that run this computer. In case of conventional computers, the user drives the computer using power. Power management is a key feature to develop a better computer. Here, the computer runs by itself, as it harvests electrical, thermal and other forms of noise. The only control the user has is before building the computer, setting its key learning parameters and domain of operation fixed. Once the computer gets running, it does not stop until serious hardware malfunction.

One of the primary features of this computer is that here the hardware that emulates the events happening in nature and most hardware generating events in nature are the same. The prime metric is not a solution of a random choice. It is a pattern of resonant frequencies of all possible cavities. The inventors are creating a generic compiled structure to emulate 99% natural events (only first 12 primes are considered) in the prime metric. Therefore, observer, the user (U) that operates the computer; the system (S) or the computing hardware and the environment (E), all three major components SUE of computer user interface act together. These three components form a singular rapidly evolving time crystal. There are two temporary time crystals in the network. The first one is created by four operating modules of the computer inside the hardware. The second one is the SUE time crystal. Both the time crystals want to match, and a generic drive to that is called “dynamics of morphing matrix”, in short MBS. Morphing dynamics is explained below in details.

The time crystals located inside the computer undergoes morphogenesis. The claim outlines five different drives to morphing.

First, unitary drive. A clock is represented as a circle, in general it is a loop. The first drive of every single component in the computer is to form a loop. The drive to form a loop or generate a periodic clocking is the first fundamental drive.

Second, CN symmetry drive. C2 symmetry means like human shape, one can nearly cut by half to find that both sides are nearly equal. There is a drive to begin constructions at the simpler levels like C2 symmetry, then at deeper levels, complex symmetries like C3, C5 and other symmetries are preferred. The vibrations of prime metric govern this drive.

Third, Fractal clock drive. If the hardware needs to find all associations of a shape, say, triangle, the system point moves to the faster clocks inside. Mathematically it can be shown that if the time taken by questioner is one second, much before the next one second, all the associations would be found. As the synchronizations go deeper to the orders faster clocks, the answer is retrieved, instantly, to the system clock.

Fourth, synchronization drive. All clocks run by white noise of various kinds in the entire hardware. The essential trigger to hardware modifications, or any physical operation come from high power amplification. This happens by high power amplification during synchronization and de-synchronization of the clocks.

Fifth, Protection drive. The temporary time crystals of SUE, and the combined temporary vibrations of four modules and the delayed writing of difference clocks are three protections of the hardware. There is no instant editing of permanent memory clocks.

<Description of the Features According to Claim 6>

Claim 6 outlines fundamental conceptual changes in the elementary machine used in this computer. The concept of information processing with a machine is based on Turing machine for nearly a century. Be it classical or quantum, the existing information theory (EIT) relies on the assumption that every single event in the universe could be represented as a sequence of simple set of events. Quantum collapse is simultaneous, but quantum computing or quantum information theory does not make an event to be an output of many simultaneous events. Process runs parallel, or simultaneously, but the sequentialization of events was never a part of quantum or classical information theory. Here, an event is fractalized. It means the universe is considered to operate by exploring singularity or undefined features. Sequential, parallel systems could be simulated using a Turing tape, but not simultaneous events. The process of simultaneity explores topology so extensively that one would require defining machines in a new way. The claim outlines that new machine, namely fractal machine. To run this machine, a new kind of tape is conceived, that is a Fractal tape.

A fractal tape is defined in this claim. The statement is “Every single cell of a Turing tape has a Turing tape inside.” This statement alone defies the very existence of a Turing tape. For that very reason, the claim has put forth a new set of four tuples, similar to the one we find for running a Turing machine. Tuples mean the steps to be taken by a machine to run the simplest computing performance. Here for a fractal tape, there are four tuples but actually they happen simultaneously, not step by step. The concept of parallel and sequential does not exist for a Fractal tape. This is explained below.

For a Turing tape, once the journey begins sequentially, where it ends is not seen, cannot be determined. For a fractal tape, the total length is set by the observers limit at the beginning. Then, there is a journey inside a single cell, and it continues until it reaches the observers limit. Entire journey happens instantly. The entire processing happens due to the intricate route of the tape. The topology of the journey or intricate path details are not to be compromised. The objective of fractal machine is to preserve the fractal path topology existing in nature at various dimensions as is. If compared with the Turing tape, a fractal tape has no motion, or operation towards any direction, it is like a static object morphing into another desired one. Every part of the tape changes and it becomes a new tape, not by shrinking, but may be by expanding or keeping the volume intact. So, there is no communication, hence no communication channel. It is the density of clocks to be morphed. The ratio of density of clocks between participating fractal tapes is conceptually close to communication channel.

One interesting aspect of Claim 6 is the mention of phase in relation to the fractal tape. A fractal tape, because of its own definition, cannot hold any defined state. Phase is neither mass, space or time. The relative phase at any instant in a 3D cell network of a fractal tape is the only fact that determines the topology.

<Description of the Features According to Claim 7>

Claim 7 addresses the elementary device to be used in constructing the computing hardware. The elementary device is not a switch that flips between zero and one like that is used in a computer. Here the elementary device is a clock that has multiple editable singularity points. In order to realize that device experimentally, a cavity resonator with rapidly vibrating boundary is required. The rapid vibration helps in generating coherent motion of carriers even under noise. At the same time, the membrane should be porous. The leaking carriers make sure that the cavity resonates at much longer wavelengths than that is allowed by its dimension and there is a push pull effect on the carriers. Therefore, the topological constraints make sure that there is a clocking behavior and local sub-loops may form to create a singularity point. The effect of topology does not remain confined with the push pull effect, it also enables the system to harvest energy from noise. An ordered topology in the membrane is an additional criterion apart from it being porous.

One additional requirement for the elementary device to be a single cell of a fractal tape would be its ability to self-assemble with similar or dissimilar neighbors to create another self-similar device. It means mathematically that several cells of a Turing tape make another single cell of a Turing tape. And experimentally it means that the self-assembled architecture would also (i) have a porous membrane, where (ii) the membrane elements would be arranged in a suitable geometry to harvest noise, (iii) push pull of leaking carriers would generate clocking, (iv) provisions would be there for several local cells running as faster clocks. Therefore, always, the four criteria have to be maintained, irrespective of the mode of device fabrication.

One important aspect of Claim 7 is setting a condition for the creation of a clock in a material or a device. Normally, in the conventional science, it is argued that a feedback is essential to run a clock. However, an alternate simple system could generate clocking or periodic oscillations without feedback. If one has a close loop and a ripple is triggered, then that ripple could run perpetually and an oscillation could be observed. Mathematically, small circles could self-assemble into a larger circle, if they do, it sets the conditions right for a continuous periodic oscillations. This is a guest host circle network. The diameter of the guest circle is experimentally the ripple width. A perfect match between sum of all the circles diameters and the self-assembled circle ensures a loss-less run of a loop. This is how a system point is born, or a clock is created. The speed of the clock is determined by the relative diameters of the guest-host cycles.

The devices generated by fractal cavity resonance follow fractal mechanics, unlike classical and quantum. In the last part of Claim 7, an obvious uncertainties could be underpinned. Some of these are outlined as the part of Claim 7.

When several clocks self-assemble, the diameters of the guest circles may oscillate, generating beating. The beating could embed some new pattern of beating inside. A beating is a source of uncertainty in a time crystal, as it modifies the relative phase relationship.

Any geometry embedded in a time crystal would appear very different to an observer looking from different directions to the spherical time crystal. It would appear differently.

Mass is represented by a highly densely packed clocks. Smaller the mass, larger is the diameter of the clocks. It means that a particle with mass zero would have nearly infinite diameter. A photon is a single host circle with closely packed multiple guest circles equal to the photon frequencies. In this scenario, any point is a superposition of many clocks, generating uncertainty.

<Description of the Features According to Claim 8>

The final claim, Claim 8, for the present invention covers two prime aspects. First, how time crystals self-assemble and what conditions trigger a self-assembly of time crystals.

There are ten ways a set of time crystals could self-assemble.

First, symmetry breaking and phase transition: There is always a giant host sphere in a time crystal, in which several small spheres embed as guests. The geometric arrangement of guest spheres forms a symmetry. During interaction with new time crystals, these ordering could change. Sometimes the change in ordering of the geometric arrangement of the guest spheres is small and sometimes it could be large.

Second, creating new clocks or destroying existing clocks to simplify the system: Fractal or self-similar clocks are replaced with simpler clocks.

Third, copy paste unknown clocks: In presence of clock network or input time crystal, the host time crystal could simply generate a replica of the new input.

Fourth, re-orient and re-write the geometric information in the existing clocks: A shift in the singularity points could change the geometric information. This is also a fundamental step in the information processing.

Fifth, C2 symmetry drive: All time crystals produced by the hardware spontaneously self-assemble and they unify following the symmetry of primes noted in the prime metric. The most abundant (66%) symmetries are C2 and C3.

Sixth, Morph to mimic evolutionary dynamics of environment: Creating and destroying the clocks to create a replica for power surge through resonance.

Seventh, Protection drive: Long term and short term drive: Temporary time crystals are born in the system of time crystal and these time crystals transform into the most matching clocking network.

Eighth, Rule of clock integration extracted: The input time crystals fractal repetition rules are extracted and copied into the host as is.

Ninth, The host expands to keep morphology intact: In most cases of self-assembly, the host time crystal expands to maintain distinctive features of the participating time crystals.

Tenth, The rule of evolution follows the mathematics of ordered factor: Often during self-assembly, the host time crystal creates a new set of clocks to bridge the missing time gaps in the existing time crystal.

Ten conditions that triggers self-assembly of clocks:

First, time cycles bond only under a certain specific condition: if a pair of time cycles or clocks has similar guest time cycles, they interact. The pair of time cycle network bond together to form a single network if any only if either of them is not pixel to another. If this is satisfied, then the pattern of local frequencies between the participating clocks should match.

Second, the density of time cycles in two interacting time crystals maintains a similarity for a longer than a particular threshold time: When similarity in the density of time crystals sustains for a long time in a loop, then two participating time crystals form a new clock and bond like molecules.

Third, the geometric information encoding process is identical to the density matching process: A time crystal is made of phase spheres. The information architecture or time crystal appears as a giant sphere made of phase points. And several small spheres of phase are located on its surface. The density of time clocks always tends to homogeneously be distributed all along the spherical surface of the time crystal. The drive for homogeneous distribution triggers a self-assembly of clocks.

Fourth, without cross checking the necessity of environment there is no creation of spontaneous and independent formation of a new time cycle: Time crystals do not self-assemble in reality just like particles do. Here self-assembly of time crystals means a replica of a time crystal is created on another. Time crystals may remain isolated forever, if beyond a threshold number of time crystals need to be replicated.

Fifth, fusion and fission of the tiny time cycle: Some time cycles are broken into small pieces or fuses to meet the need of symmetry of the hardware. This process triggers self-assembly of neighboring time crystals.

Sixth, matching the spin direction of the time cycles: The spin direction could change the geometric information held by a time crystal. Thus, matching the spin direction is essential. If not, the nearby time crystals start interacting and morphing each other.

Seventh, phase synchronization run in parallel to the geometric synchronization: Geometric shape made by two interacting time crystal is the fundamental reason for self-assembly of time crystals. However, there is another synchronization run in parallel. That is synchronization of relative phase pattern in the time crystal.

Eighth, creating a mirror image from the phase space hierarchical network by fractal route: This creation is not done by just reducing a large number of repetition geometries. In addition to the above-mentioned reduction, if the hardware finds minor addition of clocks that could generate self-similarity, this will also be taken into account on performing the above-mentioned creation of the mirror image.

Ninth, time cycle network expands and continuously tries to produce a time cycle (time cycles?) in the network which time cycle is longer than the longest existing time cycles in the network: the clocks produced by hardware are discrete, they self-assemble to generate slower clocks.

Tenth, prime frequency wheel drive: The prime metric drive is fundamental to all time crystals. It sets always criteria for selection or preference while adding a new clock or deleting the clocks that has just been created.

### EMBODIMENT

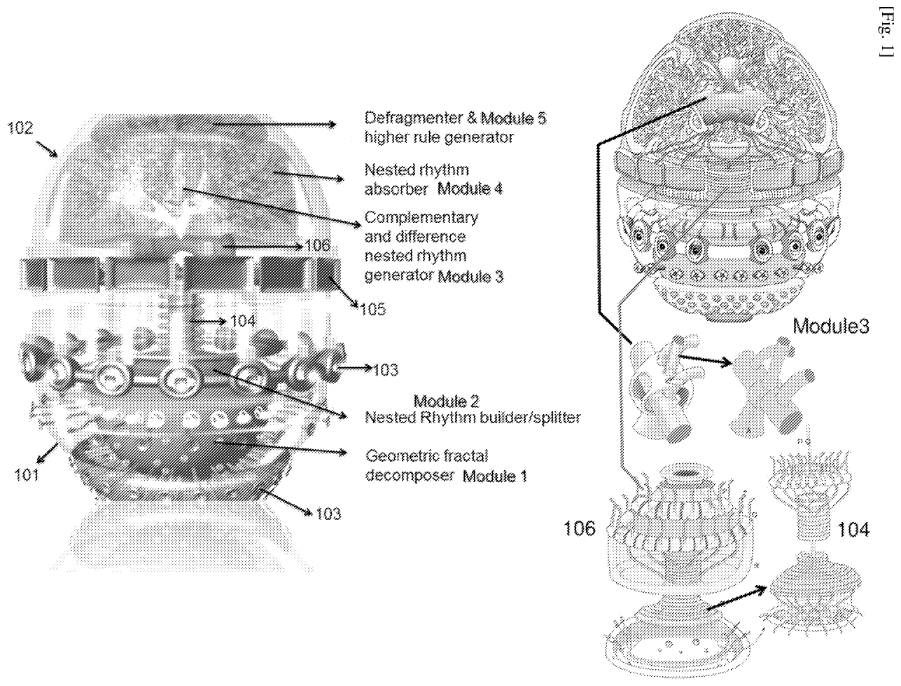

FIG. 1 outlines a generic design of the computer. Five clocking modules work as basic operational units in the computer. Each and every module is made of leaking cavity resonator that acts as a clock. All five modules are time crystal generator. Time crystal is like a crystal, but, it has clocks arranged in a 3D geometry. The clocks keep time from femto-seconds to giga-seconds and more in principle. All information is converted into nested clocks or time crystals by all five modules. The name of the five modules are, Module 1: Geometric fractal decomposer, it converts & shrinks massive sensory streams of data into a time crystal. Module 2: Nested rhythm builder/splitter, it integrates the time crystals during an input, and disintegrates the time crystal during an output. Module 3: Complementary and difference nested rhythm or time crystal generator. When the input time crystal arrives, some sections of the input time crystal already exists inside the computer. Some new time crystal could make it topologically symmetric, those are called complementary time crystal. They are built in this section. Then, some crystals are non-existent in the computer matrix, they are also created. Module 4: Nested rhythm or time crystal absorber. This module is the main decision storage unit. Here the decisions are a set of geometric shapes, so are some conditions that generates the decisions. These sets of geometric shapes are clocked together. Module 5: Defragmenter and higher rule generator: Wherever in the hardware discrete isolated time crystals are generated, this section, integrates them as a part of larger clock network. Also, it deletes the redundant clocks and could even delete a section of the clocks in the network to recreate it at more suitable place. Out of these five modules, four modules are operated distinctly. The claim explanations have detailed construction and operation of these modules.

Eight operational cycles and three drives run the computer operation. Eight operational cycles are clocks that holds all other clocks in the entire computer such that simply running those clocks resolves all operations. A simpler analogy is that all task performing clocks reside on the perimeter of a clock or circle designated as operational cycle. These eight clocks or circles are integrated by three more cycles. These three cycles are called driving cycles. All eight circles are guests of these three circles. Thus, when, three cycles run, eventually all eight circles are regulated. Below, these integrated clocking operations are explained step by step.

The computer has two major parts, 101 is the sensory unit at the bottom and 102 is the memory and processing unit located at the top part. 103 noted components are the sensors that captures the analogue signal from outside, from environments or potential users. Entering inside the computer, the signals pass through the Module 1 section of FIG. 1. In this section, the signals are converted into all possible cycles made of frequencies (time cycle=clock=rhythm=periodic triggering of a set of frequencies one after another; time cycle is represented by a circle, everywhere) and the nested cycles (interconnected cycles or circles, nested clock=time crystal) formed for each sensory signals. This is called Geometric fractal decomposer. Sensors do not convert signal digitally, uses unique fractal time sensing to capture the same signal's various time scale rhythms simultaneously. Thus, it captures all possible phase relationships between all streams of pulses from ultrafast local events to the pair of events separated by a very distant time gap. Together entire architecture represents a 3D oriented clock network.

There are three types of cycles or clocks run through the artificial brain like computer. First, storage clocks: nested memory and decision-making cycles or clocks. Second, activator clocks: nested operational cycles that controls memory and decision-making cycle activation and deactivation. Third, driving clocks: nested drive cycles that controls the operational cycles, i.e. supreme controller. All nested memory cycles are produced at the sensors directly from the analogue input. Operational cycles are similar to memory and processing cycles, however, they run between two or more functional modules. The drive cycles are also same as memory & processing cycles, but run on specific operational cycles.

Geometric fractal decomposer is the operational cycle 1 that senses and filters the analogue signals and send it to the next part. All nested cycles produced in the individual fractal decomposer one for each sensory system are sent to the Module 2 noted in FIG. 1. This job is exclusively done by operational cycle 1 in a periodic loop.

In the Module 2, two jobs run in parallel and this is controlled by operational cycle 2. First, nested cycles originating from different sensors is sent using a radiating antenna to all over the region 102, or entire memory processing region in the computer (operational cycle 2a). At the same time, nested cycles from different sensory systems add up to form a singular nested rhythm, this second class nested cycles are also radiated out using another antenna to entire memory and processing region 102 (operational cycle 2b). The same sensory signal gets into two parts, one fused and the other pure, both run in parallel.

Two classes of nested cycles, one from the individual sensors and one from the Module 2 nested cycle fusion chamber reach Module 4. Operational cycle 2a and 2b run simultaneously as part of a single nested cycle, spontaneous reply from the Module 4 matrix, which is a nested cavity structure and holds elementary memory cycles. In the module 4, the learnt nested cycles are stored as memory (this is also the processing center). It absorbs the nested cycles sent by Module 2 and the difference in the nested cycles between that already exists inside the memory & processing center 102 is distinguished & transported wirelessly to the Module 3. The difference is the learning feature that is missing in the computer memory and processing center, needs to be added. Module 3 holds all essential additions or corrections to be made in the nested cycle network until a threshold time is passed. Thus, an operational cycle 3 runs in module 3 that writes “difference nested cycle” in module 4 after a certain delay, otherwise the “to be edited” task continuously get updated.

However, another process runs in parallel. As soon as the two classes of nested cycles pour into the section 102, from the antennas of 104, the associated cycles get activated and an expansion begins, spontaneously. Thus, a small set of nested cycles expands into a large region of 102. The expansion would encompass entire 102 memory and processing units if not controlled, hence, an additional controller unit operates simultaneously, it is the module 5. This module is called defragmenter and the higher rule generator. Higher rule generator means large-scale 3D patterns of nested cycles are converted, one form to another to complete a new cycle and such relationships are written as cycles in this region. Therefore, as soon as this region of module 5 gets active, the expansion reaches a convergence.

In this module 5 section of the memory & processing region of 102, a spontaneous drive to nest local nested cycle clusters into a single cycle runs perpetually (Drive 1). Higher nesting rules for Drive 1 is saved in the module 5 and a loop runs between module 5 and Module 4. As soon as the nesting is done by integrating all newly arrived cycles and old associations, either by finding an old suitable cycle or by creating a new cycle, two prime tasks of the computer is accomplished. First, generating the solution of the problem (sensory data fusion automatically couples condition with decisions, thus, if condition cycles activate, the decision cycles or solutions are automatically triggered) and second simulating the future (future simulation=expanding the nested cycle representing a query and expanding the condition-decision cycles). Both the condition-decision outputs are essentially an outcome of the same physical process Drive 1 via operational cycle 4a and 4b. The solutions derived from these loops are sent back to the section 104 for execution of future machine task if computer is attached to the robot brain or simply to an user interface to control the sensors so that input is fine tuned, a part of it provides the output (105). 105 is therefore generates instructions for the sensory systems to edit their external signal capture parameters and in doing that delivers the output to the external user.

It is also to be noted that two similar drives to connect discrete nested cycles into a singular one also run by 104 section (Drive 2 and Drive 3). The prime objective of one drive (Drive 2) is to modulate sensory data acquisition process such that a better nesting is carried out at the module 5 and module 4. The other drive (Drive 3) delivers instantaneous solutions to problems that perfectly match the condition-solution couplet cycles stored in the Module 4, the solutions are sent to 104.

The triplet drives (Drive 1, Drive 2 and the Drive 3) are nested as one cycle or rhythm in a single hardware 104 as a singular prime drive cycle that holds the supreme control on the computer operation. There are a few local drives grow inside the three cycles.

One important local drive for the Drive 2 that manages the sensory acquisition is running a feedback loop so that when a query cycle enters module 4, and module 5 does not generate the final convergence cycle to automatically halt computing, an operational cycle 5 runs connecting 101 and 105. The nested rhythm inside expands the number of associated cyclic vibrations (rhythms) and various new cycles activate, the local nested cycles around the query part of the nested cycle network is sent as feedback to input nested cycle that is generated in 101. This is perception search protocol, using this feature, computer estimates much rigorous assumption about the query and that is verified. This particular feature enables the computer to pre-estimate what that question may appear in the future that is has not yet encountered. Thus, a query is amplified & crosschecked in a feedback loop, causing phase transition of one set of cyclic rhythms to another in module 4, and higher level time cycles (slow rhythms) activate in module 5 and trigger perception related cycles, which re-enters into feedback loop. The feedback loop continues until a slow time cycle is born that integrates all local cycles thus produced into a single loop, therefore, operational cycle 5 also helps in automated halting of the computing process.

Drive 3 is the key emergency response system of the computer, it runs via three operational cycles 6, 7 and 8. Operational cycle 6 runs in 106 where the nested cycles generated by fusion of several sensory signal generated nested cycles are analyzed as per emergency learning requirements (for humans save the physical body, reproduction and food are key fundamental filters to learn emergency protocols) are stored. Operational cycles 6 runs without using any part of module 3, 4, 5, and the fundamental learning necessity is encoded here as a cycle that filters. Operation cycle 7 runs nested clocks of periodic events. There is a permanent clock cycle in 106 for running the entire computer. A nested clock is made here and if any clock events are required to operate anywhere in the computer machine interface, repairing or even executing complex machine tasks, the nested cycles of such programs are linked to this clock. Finally, operational cycle 8 runs at 106 to decompose nested signal solutions into sensory instructions, via 105, generating nested cycle replica via antenna action and filtering the signals for external machine operation is carried out by operational cycle 8.

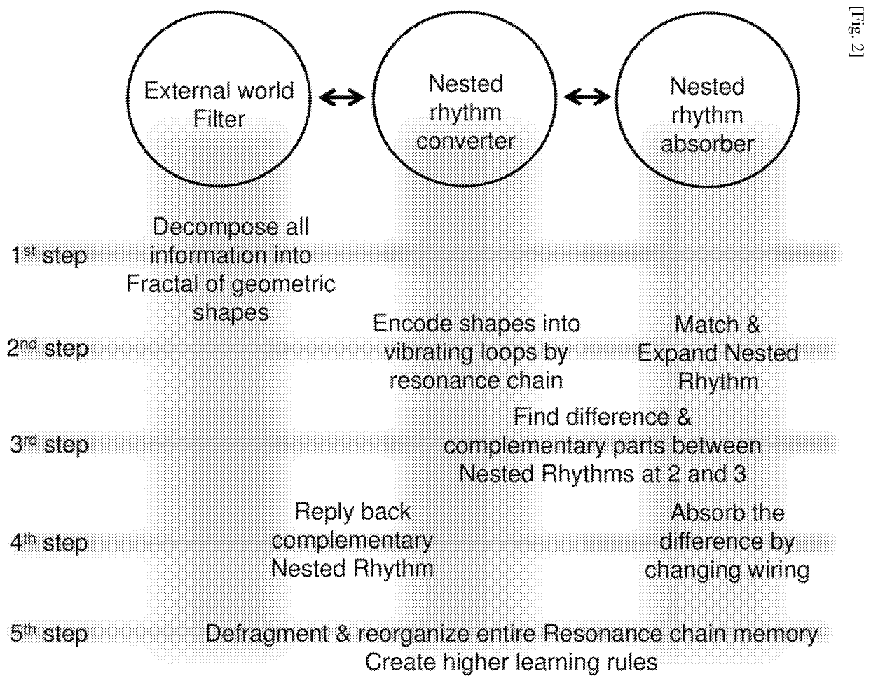

FIG. 2 summarizes computer operations described above in FIG. 1 in a table. In FIG. 1, eight operational cycles and three driving cycles were articulated to control finite number of memory-decision-making cycles to operate the computer. Three major tasks are performed by the computer in five steps, it absorbs the analogue signal from outside, converts it into nested cycles and then absorbs it into its nested cycle network.

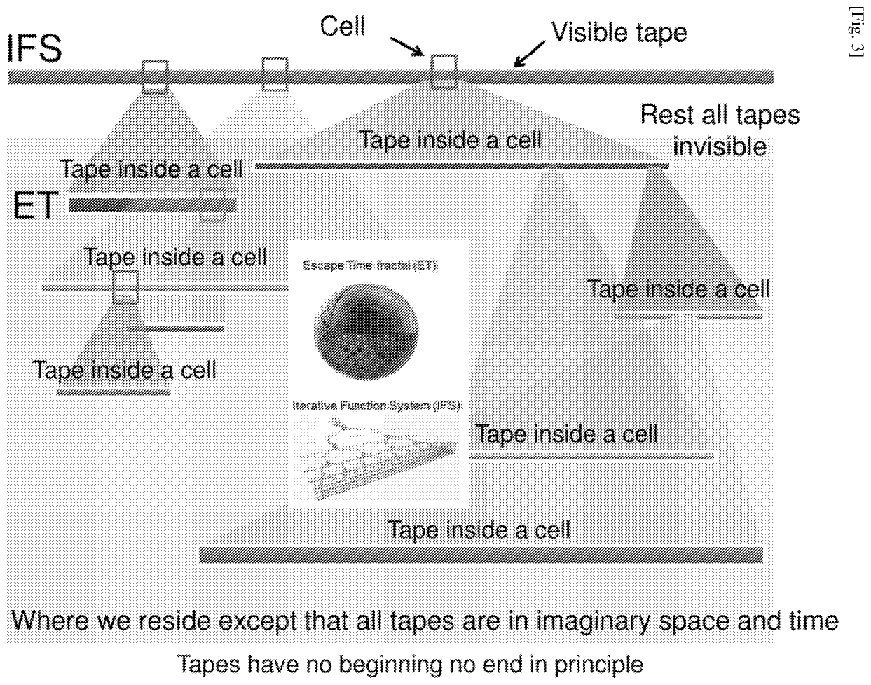

To construct or operate a computer at the elementary level, the basic requirement is a elementary decision making machine, and the fundamental principle of information integration using that machine. In a Turing tape, all each cell that makes this tape by arranging linearly has a finite state, using four tasks of a typewriter one can operate this tape, four steps are (i) select (ii) read (iii) write (iv) move. For a fractal tape, each cell has a tape inside, so no cell state is defined (FIG. 3). If there is no defined state for a cell, the Turing tape would not be operable. For the present invention Turing tape is not useful as none of the states of the cell of the Fractal tape is defined. For this computer, the fractal tape is used as a tape that contains phase as the only variable. As the phase changes 360° one gets time. One interesting aspect of using phase or time is that the inverse of time is frequency and if a frequency structure is made, the entire information architecture could be converted into a material. One to one correspondence between a material structure and its information content is a key feature of the computer hardware.

Fractal tapes are two types, first, iterative function system (IFS) wherein the repeated geometries are located side by side and second, escape time fractal (ET) wherein the repeated geometries are not visible until we zoom a particular pixel in a pattern (FIG. 3 inset). IFS type structures and its information processing is emulated by Turing machine, for ET type, fractal tape is needed. The computer of present invention uses both IFS and ET type structures. The elementary cell used in the computer is a cavity resonator that runs a cycle or a cavity that plays a strictly defined set of frequencies one after another. There are plenty of cavities inside a cavity and that satisfies only one criteria for making the fractal tape. The second requirement is critical, that is since each cell is not defined how to use it.

While measuring the cell state of a fractal tape, a detector measures weighted time average values of all cells within that single cell and the cells above (both worlds are in IFS fractal arrangement), any detector or observer has a upper time limit and a lower time limit. Hence a detector that is also an IFS fractal sees (by resonance) only a part of the nested cycles in the measuring cell, the detector or observer could be another cavity resonator or cell. Thus, cells when read does not have effect of its states alone, cells inside (F(z₁), z->i₁) and cells above (F(z₂), z->i₂) (ET fractals) and cells in the neighborhood tapes (F(z₃), z->i₃) (IFS type cells), all affects (F(z)=F(z₁)+F(z₂)+F(z₃)). Therefore, three imaginary terms F(z₁), F(z₂) and F(z₃)) affect the cell state F(z) at any given time (note that every fractal system have its own fractal equation F(z) like Mandelbrot fractal say F(z)->z−z²−1). Here F(z₃) is an observer, what it observes in such system is not only function of its own complex nested cycles made of z₃, but also how inner and external worlds of the cell z, and z₃ affects z. Also note that i₁, i₂ and i₃ are all independent they cannot be equated as i. Since the world of z₁ and z₃ are two distinct IFS worlds, therefore it is always three IFS fractal worlds and their own distinct dynamics that determines the cell state or fundamental information of the present invented computer.

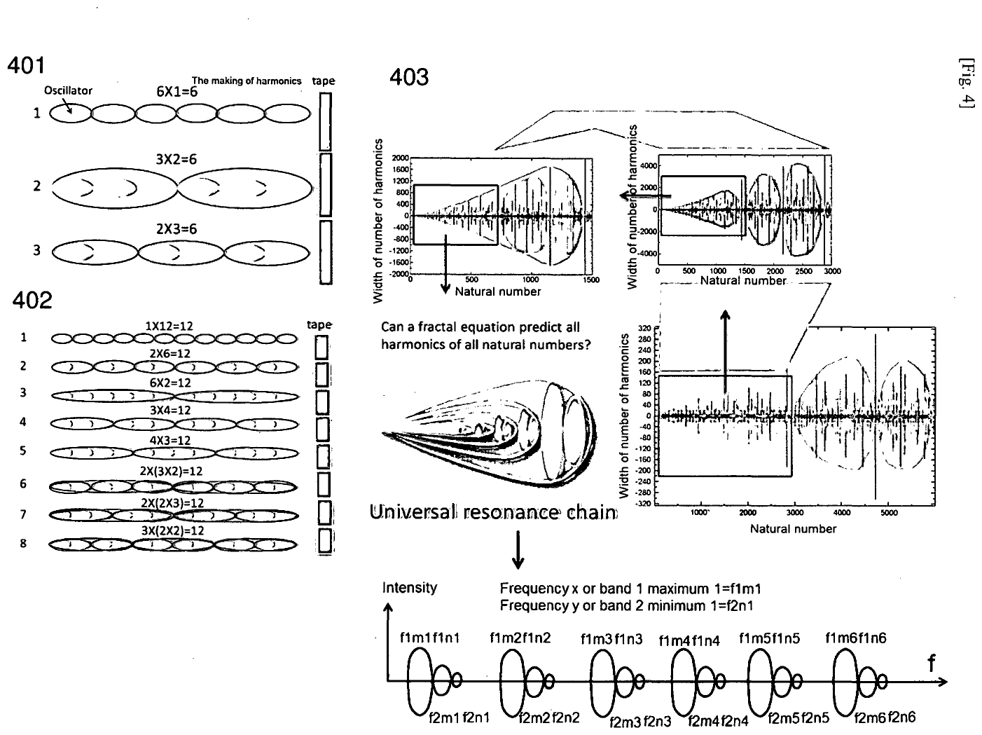

Inventors envisioned fractal cavity resonator network based on ordered factor metric of the number system so that entire architecture of the computer grows by itself. The basic philosophy for constructing this metric is that the resonance frequencies of all possible cavities in the universe could generate a topological feature. That topology if followed to construct a computer hardware, it's natural vibration would match the clocking events in nature more profoundly, naturally. The metric turns out to be the real user of the hardware, it runs by itself. Instead of an external user uses the computer, the prime metric hardware reads outside environment. In the true sense, the inventors have conceived an user, not a computer. FIG. 4 outlines the construction of a prime metric or number system metric for constructing the fractal tape machine for this particular invention though there could be several other ways to construct an equivalent of this tape. Ordered factor metric is based on the concept of nested cavity resonators. Here, the number of waveforms is increased one by one in a cavity resonator and then the total number of distinct compositions could be created keeping those waveform-generated nodes as static nodes are counted (known as ordered factor, 401, and 402), the magnitude is halved and plotted against the natural number. Two cavity resonator examples are noted, one in 401 of FIG. 4 for 6 waveforms and another in 402 of FIG. 4 for 12 waveforms. Vertical line width=number of nesting of cyclic oscillations in 403 of FIG. 4. In the plot, several teardrop-like patterns emerge as fractal, if cavities are arranged following the initial simple cavities wherefrom the teardrops emerge, then natural self-assembly drives system towards a nested cavity architecture.

In the bottommost panel of 403 of FIG. 4, pear arrangements of various scales are placed side by side, it is called the resonance chain. If energy is applied to any part of this chain, the energy is distributed all over the chain, due to the fractal network. Thus, the computer harness noise and several energy sources available in the locality feeds to its power supply, without any wiring. Only white noise harvested resonant energy transfer is used to power supply the computer.

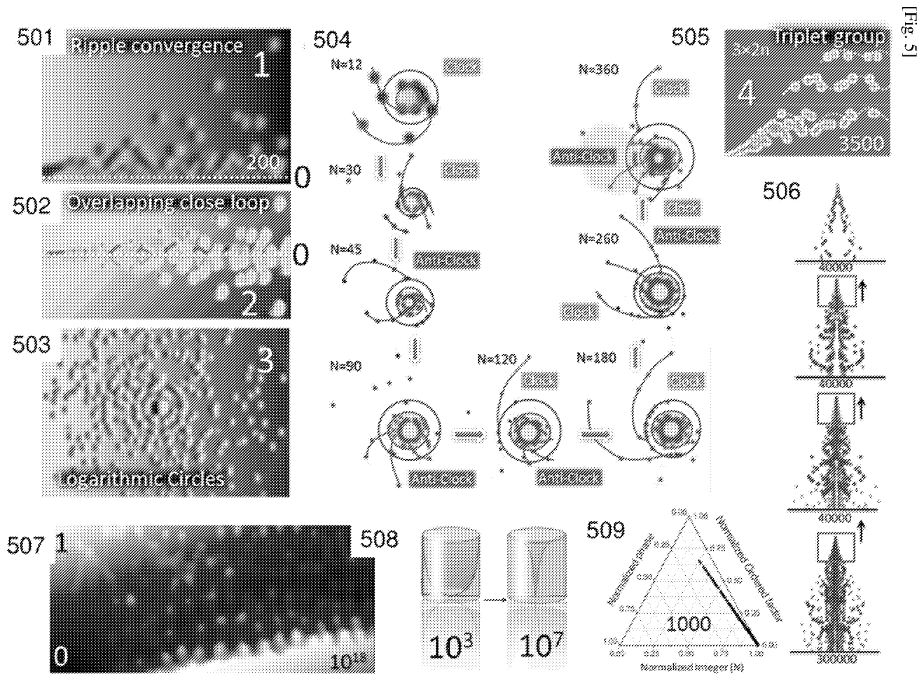

FIG. 5 explains the formation of prime metric. Twelve prime metrics are formed by plotting the same ordered factor of an integer in 12 different ways. Vertical axis always represents ordered factor or OF of a number N. 501. First metric, N=200, one damping ripple of ordered factor is shown. Several such ripples form and damp as N increases. 502. Second metric, OF/2 vs N plot shows vertical parallel lines along with connecting shapes. 503. Third metric, polar plot of OF, for N=10⁹, period N=360. New cycle begins at 361 and then again at 721, etc. Here, all OF points are connected by line. We get a gap. These gaps make circles. 504. Fourth, fifth and sixth metric are derived for N<360. For a given N, (<360), 1-N numbers are multiplied to reach 360, and thus complete a polar loop. Radius of circle is OF. Then, we see three events to unfold. (1). Alternate creation of 3 clockwise and 3 anti-clockwise spirals. (2). At a time only a few spirals are active, the rest sinks inside a circle. (3) A pair of active incomplete circles regulate the formation of spirals. This circle is the activity zone of the metric. 505. Seventh metric. If only those N, which are products of 3 and 2 are plotted we find OF-N metric which shows layers of nearly constant distinct oscillating lines. It is the sign of triplet groups governing the metric. 506. Eighth and ninth metric. If only those N, whose OF>N are plotted, we find a unique pair of metric. The first one is a central core with a unique pattern. The second one is a triplet. 507. When convergent ripples of primes are plotted similar to panel a, we get a new network of waveform. This is tenth metric. 508. The slopes of OF with N increases to 90°, as N increases to 10⁷. This is two imaginary transformation of discrete OF points into a 3D prolate shape. 509. The triangular plot of N, their phase and OF makes a linear line suggesting that phase is quantized in prime metric. The detailed explanations of the claims analyzed.

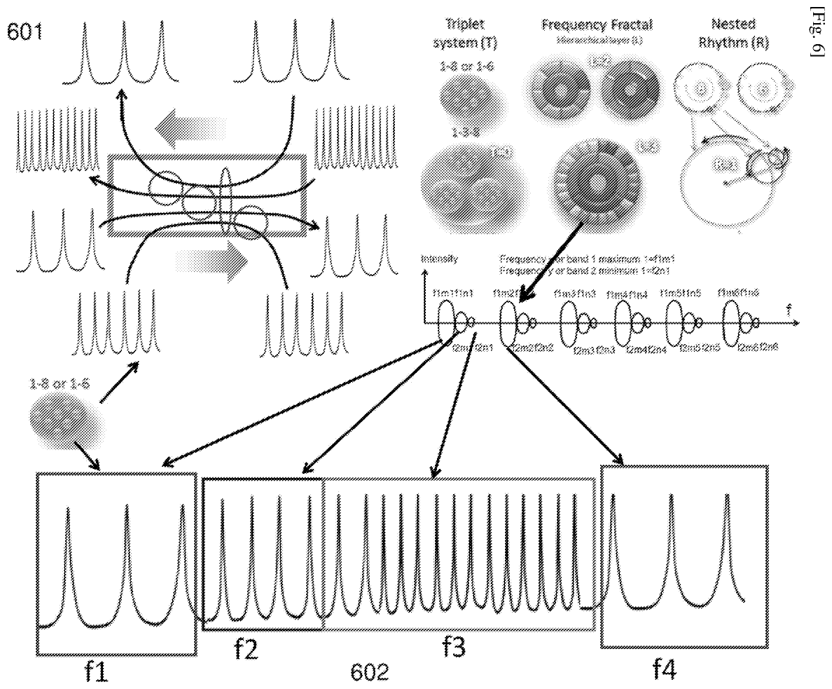

FIG. 6 explains the construction of frequency wheel that represents the information processing architecture of elementary machines to the full scale computer. In FIG. 6, 601 shows schematic of a cavity resonator wherein multiple waves pass through at their respective resonance frequencies. This is what happens inside a device. Panel 601 shows four such frequencies. There could be six or even eight. When one sees transmission of four frequencies through a device it looks like panel 602. The same information looks like four vertical lines in the resonance chain (width of the line=ordered factor, OF).

In 601 and 602 of FIG. 6 only four frequencies are shown, there could be six or eight frequencies, then it could easily be represented as one signal with a time period that is sum of others time period. This is represented as one continuous circle and another circle with a larger diameter around that is divided into six or eight parts. Now this is one circular unit, the nesting is represented as eight small disks inside a disk, or eight small circles on the perimeter of a circle. Now these circles represent a continuous periodic oscillation, as system point moves along the perimeter, the frequencies are played at specific intervals. When three such discs or circles get connected a triplet forms. This triplet is the unit of information in this computer.

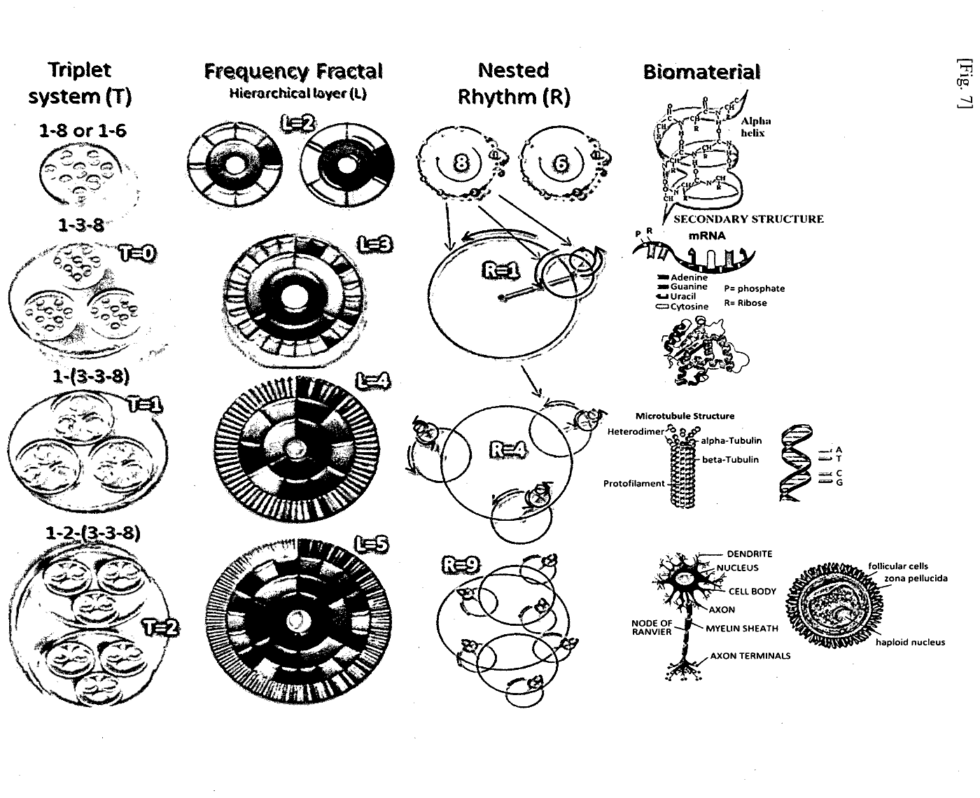

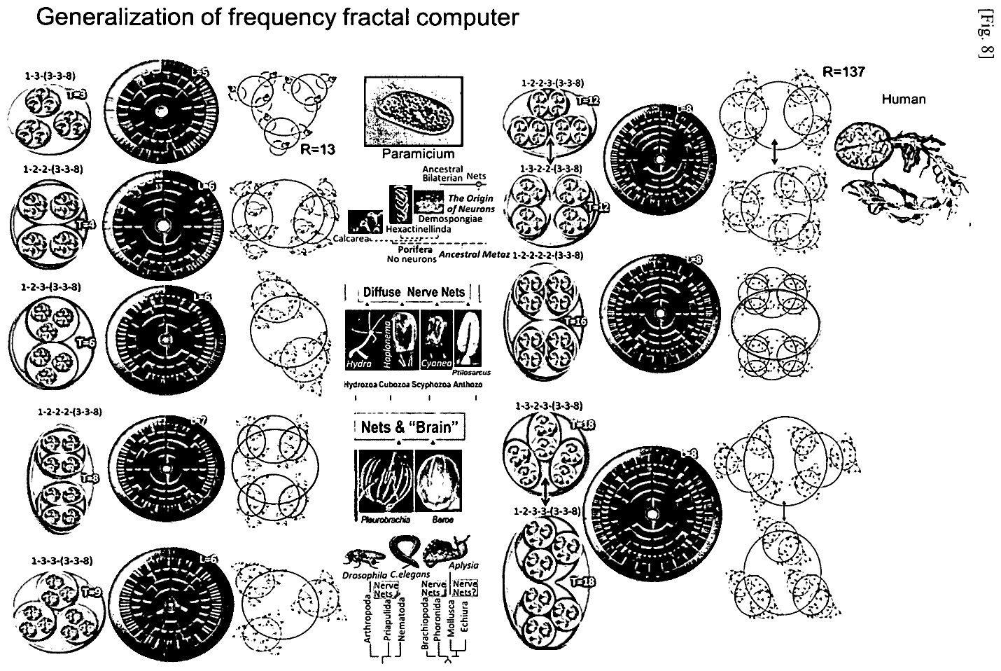

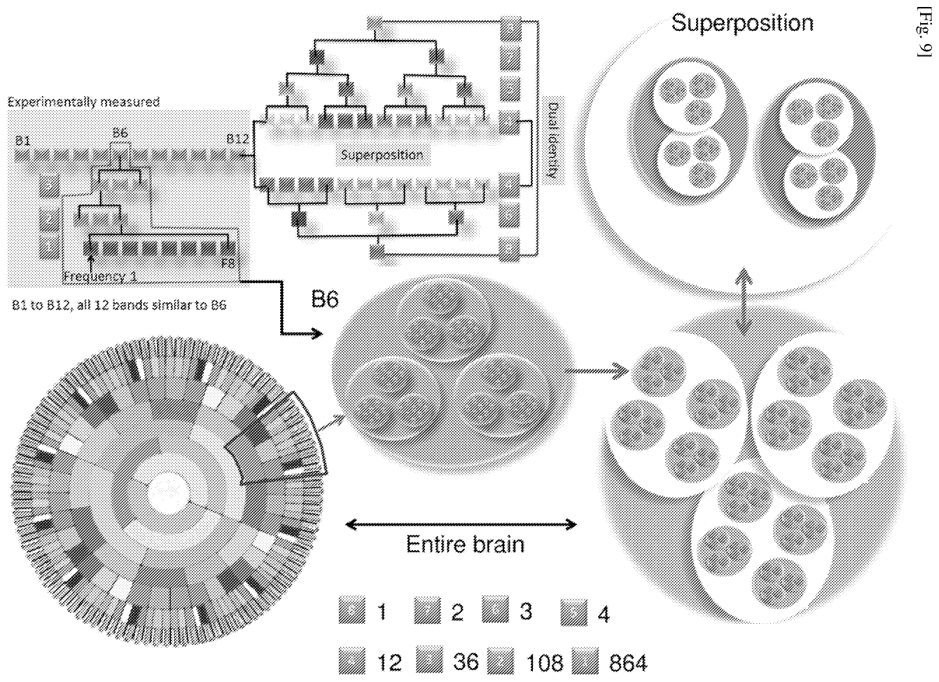

FIG. 7 and FIG. 8 are one table representing the self-assembly of triplet information unit described in FIG. 6. Each row presents one version of computer of the present invention. The computing power increases as one moves down the row. Based on the resonance frequency measurement data on the biological materials triplet of triplet network is used as a basic unit and several such units are self-assembled in FIG. 7 and FIG. 8 table. The biological equivalent machines are shown to the right. It should be noted that FIG. 7 and FIG. 8 table considers triplet of triplet (3×3=9 bands) case. One could generate entire table using 3×5=15 bands. The construction process is shown step by step for 12 triplet-triplet bands in FIG. 9. The two probable solutions for 12 bands is also shown schematically. In case of 12 triplet-triplet bands 2×2×3 and 3×4 are two ways following which entire band could be created. This enables the computer to operate with one nested cycles and monitor/evaluate the entire information structure from an alternate system point.

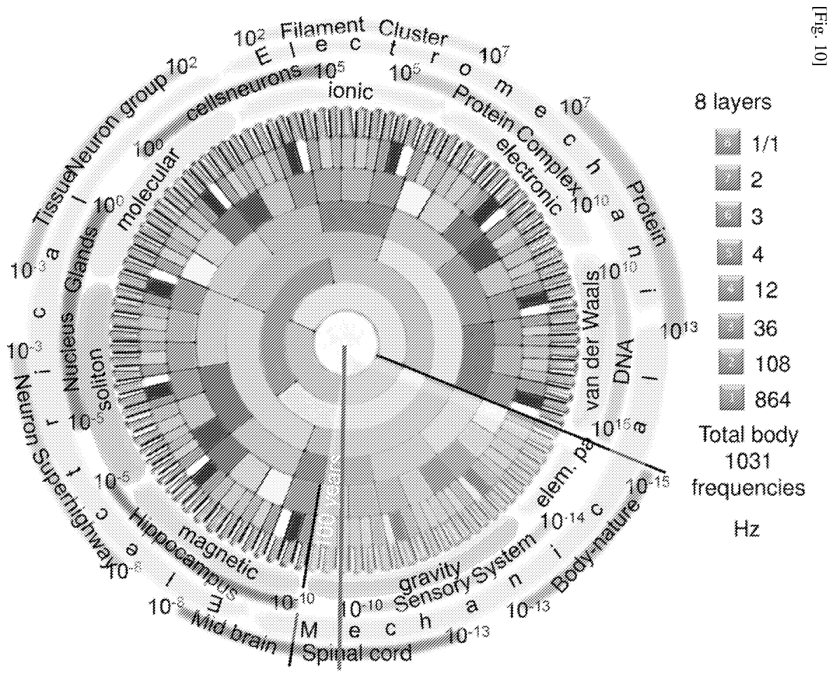

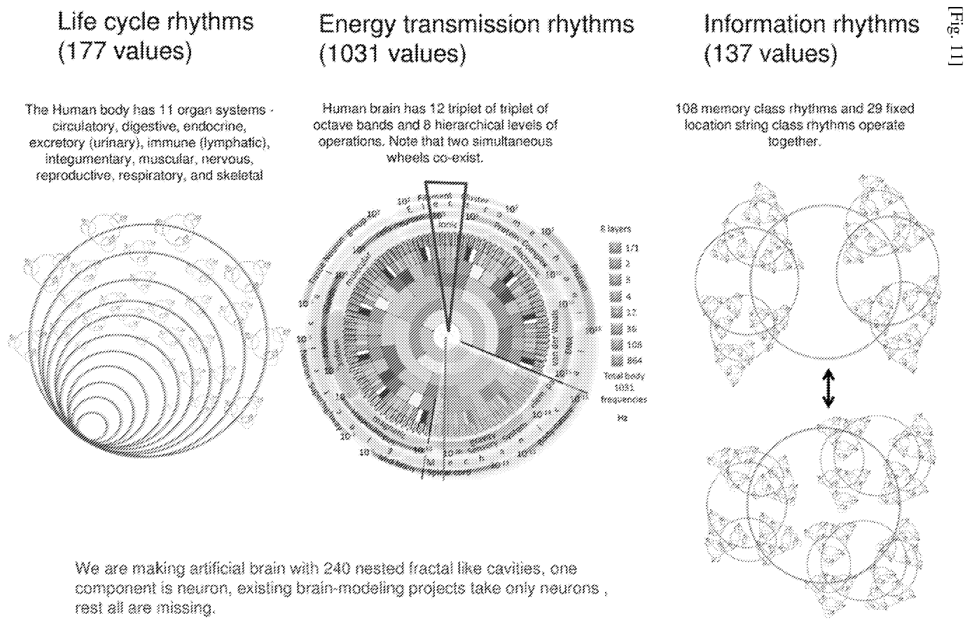

A complete map for the human brain is shown in FIG. 10, which is the same as FIG. 9, but frequency ranges are shown. The computer of the present invention need not to follow exact frequency ranges, that would vary depending on the used materials for constructing the cavity resonator. Also the frequency wheel for human brain specifically argues that the present invention is not limited to the use of electromagnetic resonance frequency, rather, it could be magnetic, mechanical, electrical, solitonic, even gravity may play a role, all depends on the geometric structure of the cavities. FIG. 11 shows summary of any computer of the present invention under the perspective of a human brain. Here three complete human brain maps are shown. From left to right, those are 177 cell replacement cycles, which for an artificial brain refers to the replacement of cavity resonators from the computer hardware. Tiny cavity resonators at the smallest scale may undergo irreversible cavity-shape deformation. Then replacement is essential. In the center 1031 frequencies for memory & information processing and in the extreme right, its nested cycle equivalence. Any computer according to the present invention uses these three nested cycles for self-survival and self-operation.

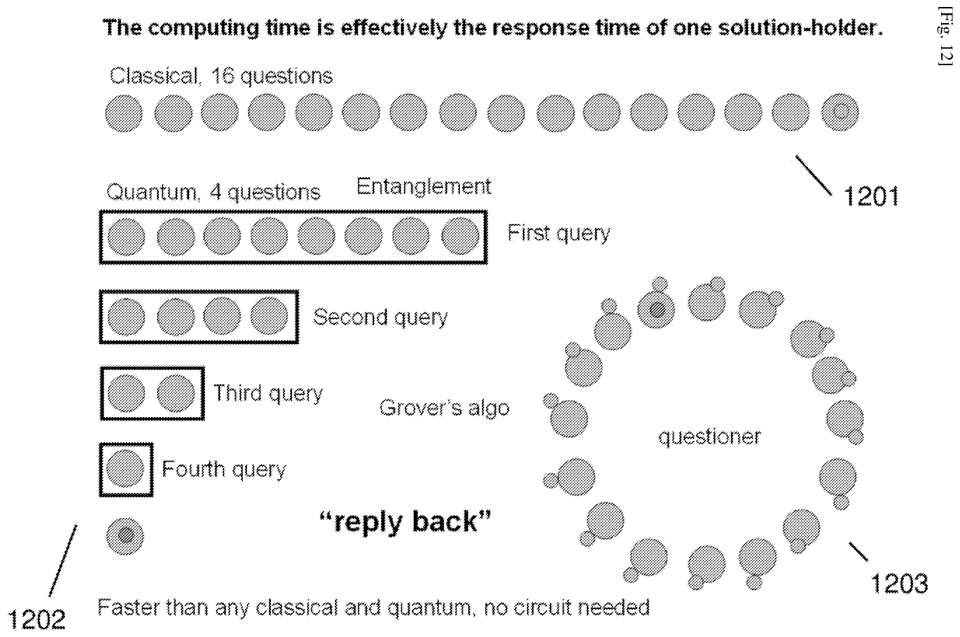

FIG. 12 shows that in classical search, one has to reach out to memory spaces using massive wiring to find the right choice. Similarly, for quantum computing one requires circuit. However, during search, when a search engine emits wave, the cavity resonators receive and the right cavity resonator holding the answer spontaneously emit signal to the search engine. Thus, search is performed without searching.

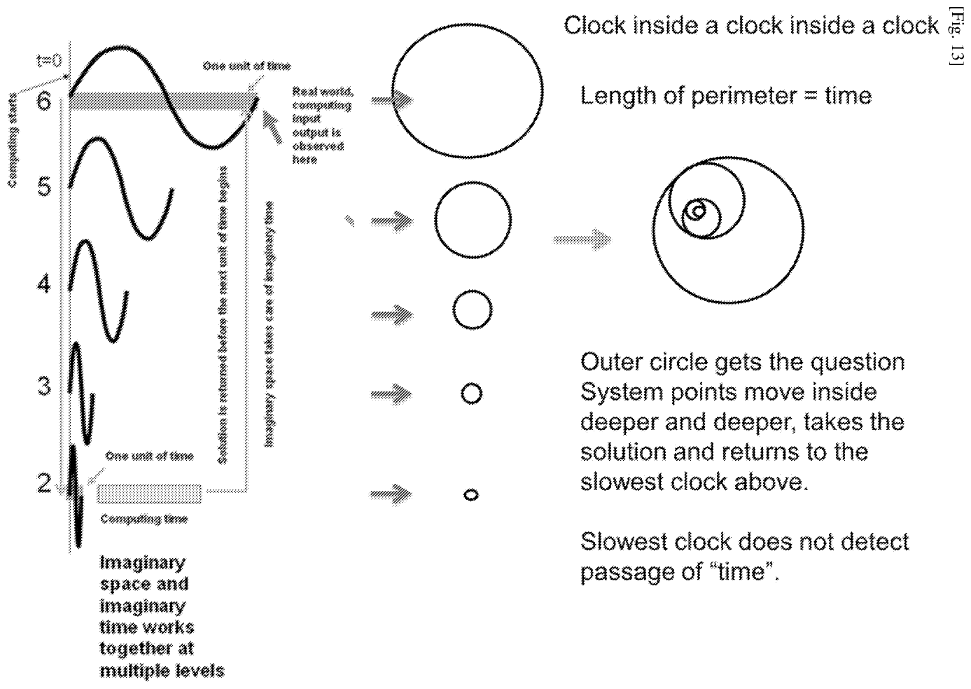

FIG. 13 shows the use of resonance chain as nested clock. Query enters as nested cycles in the longer wavelength layer of the computer architecture and it is passed down to the shorter wavelength domain, solution is derived and sent to the longer wavelength up the chain. Before a single tick in the slower clock above the solution arrives.

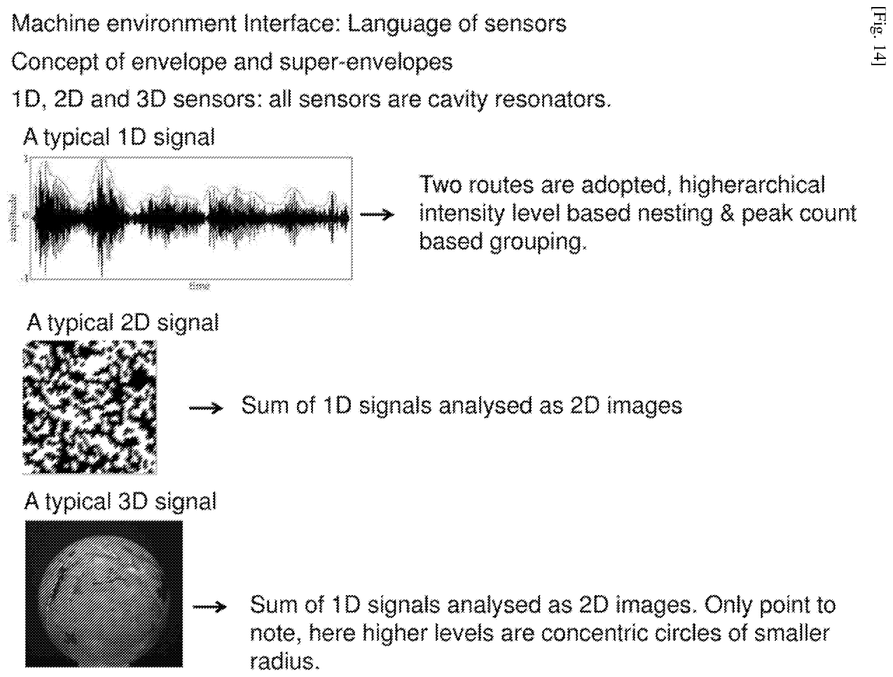

FIG. 14 is schematics of the information processing protocol of the computer according to the present invention. In these Figures, three features of the computer are described. First, how exactly the information is processed for ID, 2D and 3D signals; second, halting condition; third how nested cycles learn; fourth, how different sensory signals fuse in the cycles or rhythms; fifth, how self-assembly of cycles have one and only one drive, construct a sphere and that singular drive generates all other drives.

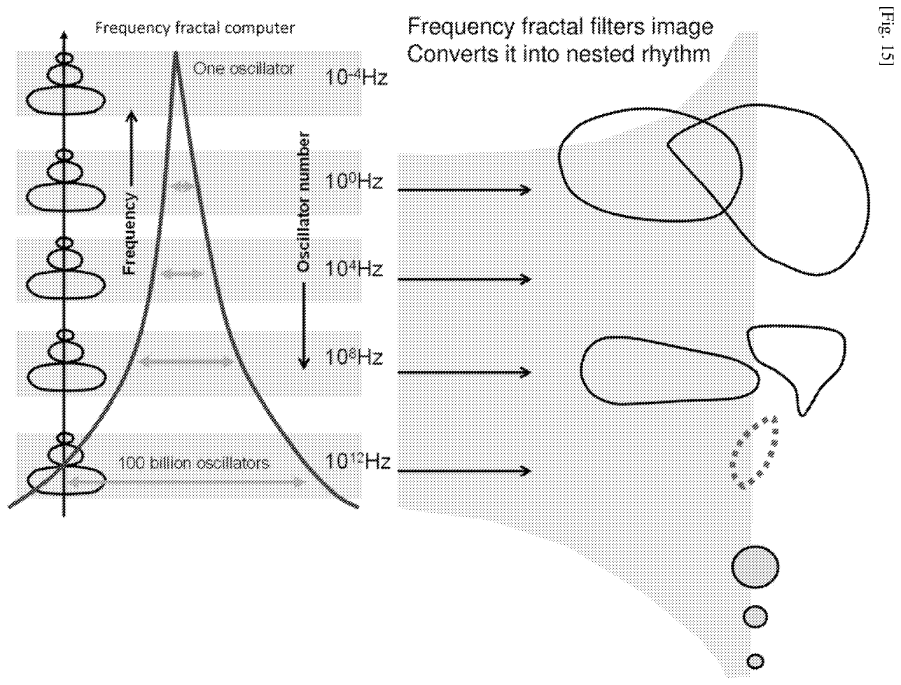

FIG. 14 outlines the sensory signal capture protocol for ID, 2D and 3D signals. As noted multiple times, the strength of the present computer invention is that the signal that comes from environment is analyzed uniquely so that its hidden intelligence is automatically retrieved. Two particularly useful tricks are used. First, hierarchical intensity level in a 1D signal is extract as shown in FIG. 15, then it is converted into a nested cycle. Second, long distance hidden grouping are also taken into account and a nested cycle is formed as shown in FIG. 15.

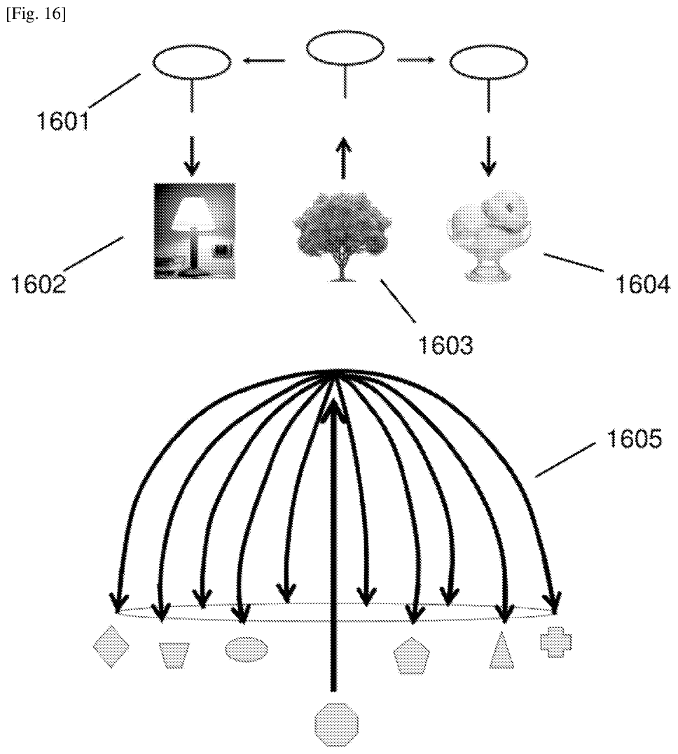

During computation a number of drives and operational cycles run simultaneously for perception search. A problem converted to nested cycles expands inside and the computer of the present invention undergoes massive search for the estimated expansion of the query to the external environment. Conventional computers take the query as an absolute truth and directly go for a match of the keywords. The present computer claimed for the present invention, run a feedback loop to enhance memory and the umbrella like protocol is shown in FIG. 16 where association is determined and crosschecked with the input problem.

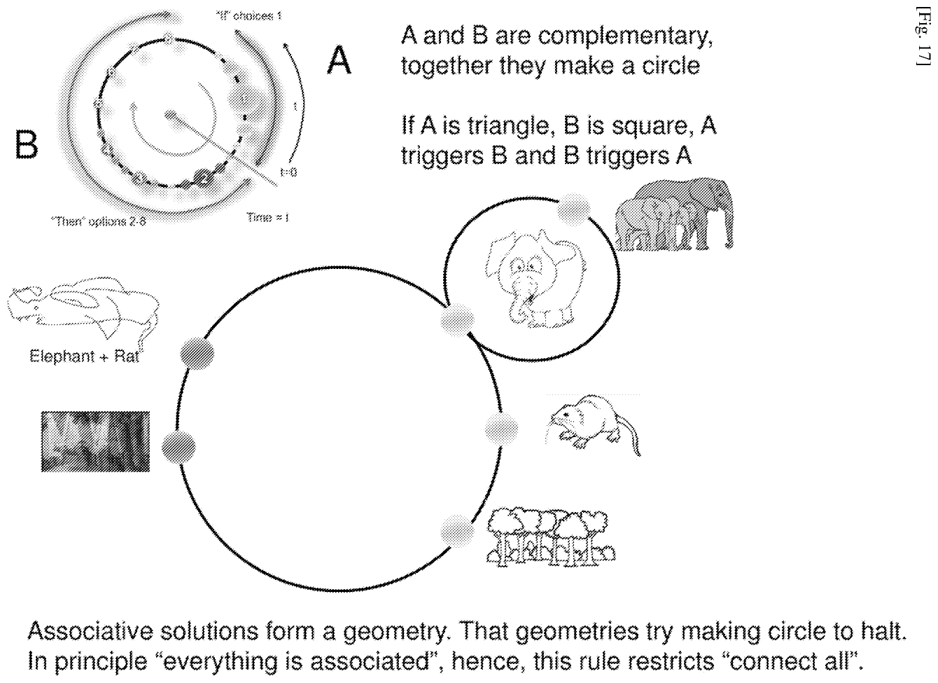

The computer analyzes the image following a route shown in FIG. 17. Creating and bringing all into a single loop is the process of computing and as soon as a loop completes, the solution is achieved. The similar mechanism acts for the automated halting. Several functional local nested cycles form a loop during self-assembly, the growth of triggering multiple nested cycles stop.

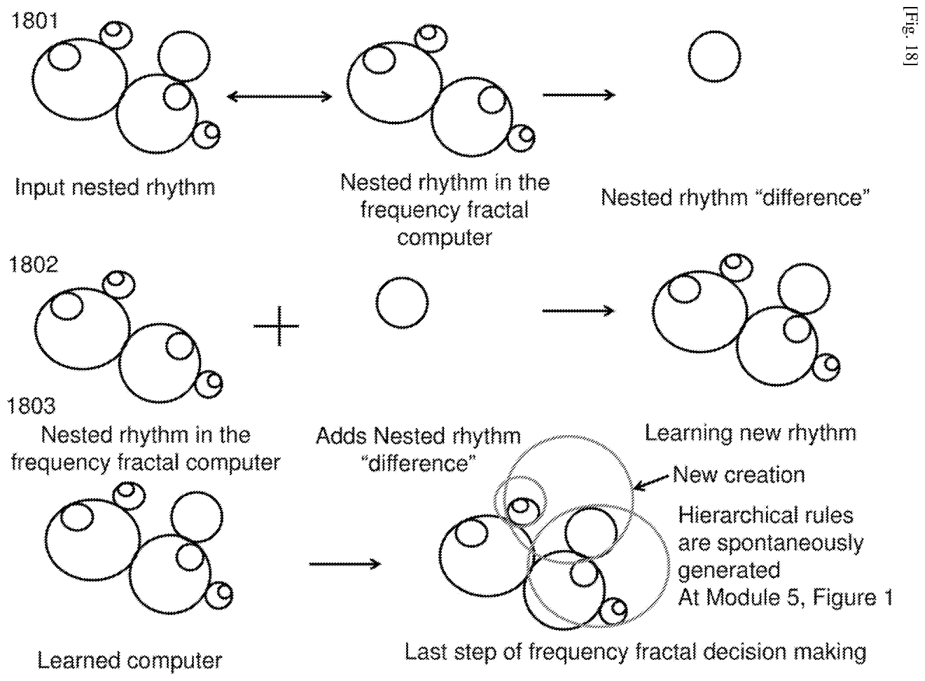

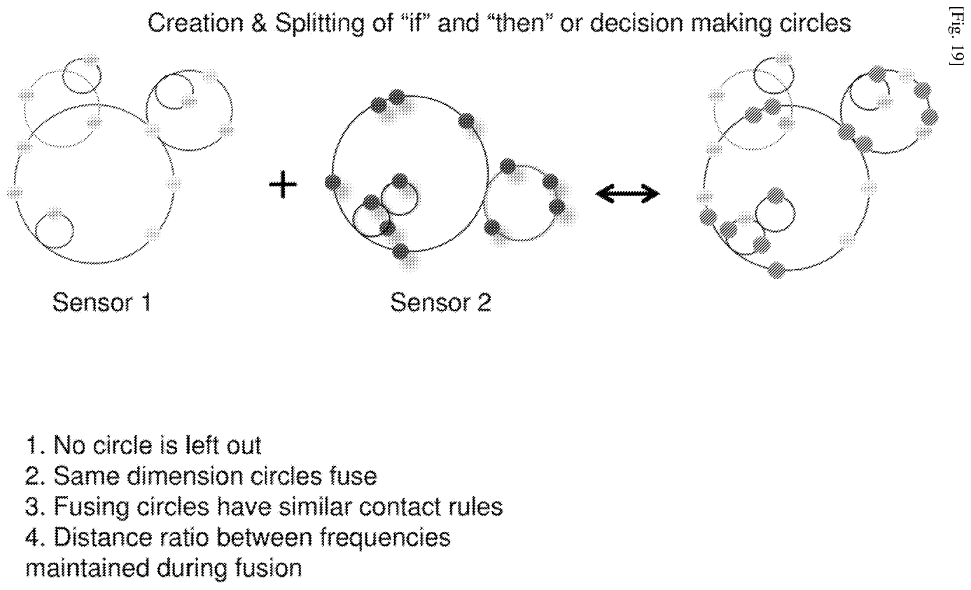

During computing, input nested cycle and nested cycle that learnt by the computer previously undergoes synchronization process. In the process the difference nested cycle is detected (section 1801 of FIG. 18), and then added to the main system by specifically designed rhythm (section 1802). However, the addition of new cycles is not enough, the time cycles always need to be balanced following a spherical symmetry, to do that new cycles continue to form which generates hierarchical learning (section 1803). Connecting different nested cycles and fusion of nested cycles are very different procedures. Fusion of sensory nested cycles is delicate since in one hand computer must not destroy the purity of the sensory information, second, fusion should make them as a singular argument. Therefore the following protocols are followed (FIG. 19). (i) Only the nested cycles are used for fusion, not elementary geometric information; (ii) Only those cycles join into one loop which does not destroy the geometric information, else a new cycle forms and entire sensory cycles are connected as two independent components of the same loop (FIG. 19).

Spherical symmetry creation is the supreme and singular drive of this computer. Every single cavity, nested cycles is architecturally programmed to execute this drive.

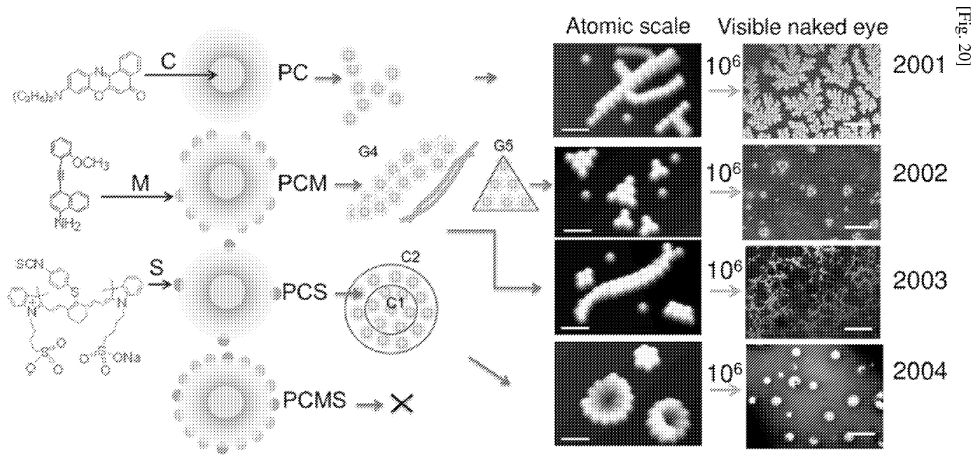

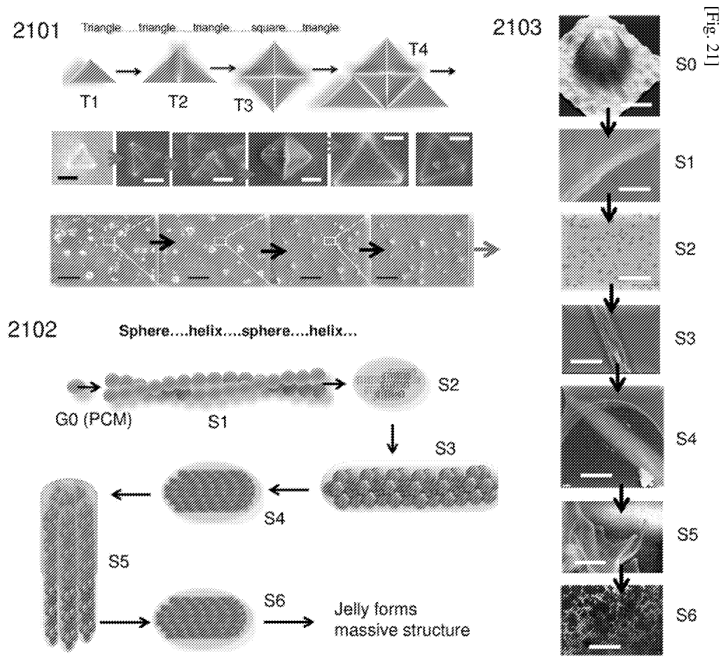

In FIG. 20 we have plotted organic molecular jelly showing the EEG behavior. The Fractal like clocking architecture forms in the system that operates like a brain like computer exhibiting several brain like features. EEG signals originate from the fractal like hardware of the system. In the organic molecular jelly by applying a set of input frequency new architectures are built, which shows its own clocking behavior (FIG. 21).

<Appendix I the Resonance Band of the Human Brain (the Brain Data Following the Frequency Fractal Wheel is Plotted in FIG. 8, FIG. 9 and FIG. 10):>

We carried out direct experimental electronic resonance band measurement for DNA, proteins as shown in FIG. 2, microtubules and organic structures, neurons and their clusters, took EEG and other data for the global scale measurements. Microhertz resolution could be measured without noise trouble. Below microhertz, large time domain data was collected and based on the slopes nano hertz to femto hertz data are produced. Triplet of triplet resonance bands is observed every single layer, in each of the three sub-bands in a single triplet. There are eight “fundamental resonance peaks” and numerous other resonance peaks as shown in FIG. 5. Finally we have generated the resonance band of the entire brain as shown in FIG. 9. Here are 12 bands of a brain, first six bands are experimental data, rest six bands are derived from other researcher's brain data. Note that the computer according to the present invention follows the frequency wheel, not the values of the human brain accurately. Any frequency wheel described in FIG. 6 and FIG. 7 and further following the same principle falls under the present invention.

(1) First resonance band A DNA molecule acts just like a single molecule oscillator, has three resonance bands (10¹⁰˜10¹⁶ Hz, gap in order 6) Triplet 1 (1-15 GHz, 16-40 GHz, 50-75 GHz), Triplet 2 (10-19 THz, 50-80 THz, 100-228 THz), Triplet 3 (1-5 PHz, 7-10 PHz, 12-18 PHz). 400-800 THz are visible light region, Peta hertz is in the extreme blue domain.

(2) Second resonance band: A single Tubulin acts just like a single molecule oscillator, has three resonance bands (10⁷˜10¹³ Hz, gap in order ˜6) Triplet 1 (50-140 MHz, 180-250 MHz, 300-400 MHz); Triplet 2 (12-18 GHz, 25-50 GHz, 100 300 GHz), Triplet 3 (8-20 THz, 22-30 THz, 35-60 THz). 300 GHz to 1 THz is the inaccessible THz band, wherein for a long time we had a technological gap. Terahertz radiation is emitted as part of the black-body radiation from anything with temperatures greater than about 10 kelvin, so does DNA and Tubulin, both DNA and Tubulin resonates with IR and UV.

(3) Third resonance band: A single microtubule, acts just like a single molecule oscillator, it has resonance bands (10⁴˜10¹⁰ Hz, gap in order 6) Triplet 1 (15-20 kHz, 25-80 kHz, 100-300 kHz), Triplet 2 (10-19 MHz, 20-40 MHz, 100-228 MHz), Triplet 3 (1-5 GHz, 7-10 GHz, 15-30 GHz).

(4) Fourth resonance band: Microtubule bundle inside a neuron say axon, synapse, the local core skeletons, which is made by coupling multiple microtubules by MAPs, acts just like a single molecule oscillator, has the following triplets (10²˜10⁷ Hz, gap in order ˜5) Triplet 1 (100-200 Hz, 250-400 Hz, 500-800 Hz), Triplet 2 (15-20 kHz, 25-80 kHz, 100-300 kHz), Triplet 3 (500-800 kHz, 1-5 MHz, 10-19 MHz).

(5) Fifth resonance band: A single neuron is made by coupling several axon bundles acts just like a single molecule oscillator, it has the following Triplets (10⁻¹˜10⁴ Hz, gap in order 5) Triplet 1 (0.1-1.2 Hz, 1.3-2.5 Hz, 3-7 Hz), Triplet 2 (8-13 Hz, 14 80 Hz, 90-300 Hz), Triplet 3 (800 Hz-3 kHz, 4-10 kHz, 12-30 kHz).

(6) Sixth resonance band: Neuron bundle like cortical column is made by coupling several axon bundles acts just like a single molecule oscillator, has the following Triplets (10⁻⁴˜10¹ Hz, gap in order 5); Triplet 1 (1×10⁻⁴-8×10⁻⁴ Hz, 25×10⁻⁴-80×10⁻⁴ Hz, 120×10⁻⁴-260×10⁻⁴ Hz), Triplet 2 (1×10⁻¹-8×10⁻¹ Hz, 10×10⁻¹-25×10⁻¹ Hz, 30×10⁻¹-50×10⁻¹ Hz), Triplet 3 (1-10 Hz, 10-15 Hz, 18-30 Hz).

(7) Seventh resonance band: Cortical column bundle like fractal unit is made by coupling several cortical columns or rhythm clusters acts just like a single molecule oscillator, has the following Triplets (10⁻⁶˜10⁻¹ Hz, gap in order 5); Triplet 1 (6×10⁻⁶-25×10⁻⁶ Hz, 30×10⁻⁶-80×10⁻⁶ Hz, 105×10⁻⁶-260×10⁻⁶ Hz), Triplet 2 (0.5×10⁻³-1×10⁻³ Hz, 2×10⁻³-12×10⁻³ Hz, 15×10⁻³-40×10⁻³ Hz), Triplet 3 (0.8×10⁻¹-1.2×10⁻¹ Hz, 2×10⁻¹-4×10⁻¹ Hz, 5×10⁻¹-12×10⁻¹ Hz).

(8) Eighth resonance band: Functional module made of several fractal-like-cortical column assemblies acts just like a single molecule oscillator, (10⁻⁸×10⁻⁴ Hz, gap in order 4); Triplet 1 (9×10⁻⁸-16×10⁻⁸ Hz, 19×10⁻⁸-28×10⁻⁸ Hz, 30×10⁻⁸-55×10⁻⁸ Hz), Triplet 2 (3×10⁻⁶-15×10⁻⁶ Hz, 16×10⁻⁶-26×10⁻⁶ Hz, 35×10⁻⁶-65×10⁻⁶ Hz), Triplet 3 (7×10⁻⁴-16×10⁻⁴ Hz, 18×10⁻⁴-25×10⁻⁴ Hz, 30×10⁻⁴-55×10⁻⁴-Hz).

(9) Ninth resonance band: Sensory and sub-functional-modules (sensory organs, nucleus, mid brain sub organs) and organizational components (hippocampus, cerebellum) are formed by circuiting several functional modules by massively complex linear wiring of neurons acts just like a single molecule oscillator, (10⁻¹⁰×10⁻⁶ Hz, gap in order 4); Triplet 1 (5×10⁻¹⁰-12×10⁻¹⁰ Hz, 14×10⁻¹⁰-27×10⁻¹⁰ Hz, 32×10⁻¹⁰-57×10⁻¹⁰ Hz), Triplet 2 (9×10⁻⁸-17×10⁻⁸ Hz, 18×10⁻⁸-31×10⁻⁸ Hz, 35×10⁻⁸-63×10⁻⁸ Hz), Triplet 3 (8×10⁻⁶-16×10⁻⁶ Hz, 17×10⁻⁶-28×10⁻⁶ Hz, 30×10⁻⁶-53×10⁻⁶ Hz).

(10) Tenth resonance band: Brain functional modules connected by superhighway neuron bundles forms a single giant oscillator (e.g., spinal cord, forebrain, left and right brain, entire mid brain) (10⁻¹²˜10⁻⁸ Hz, gap in order 4); Triplet 1, (7×10¹²-13×10⁻¹² Hz, 15×10⁻¹²-29×10⁻¹² Hz, 33×10⁻¹²-56×10⁻¹² Hz), Triplet 2 (5×10⁻¹⁰-18×10⁻¹⁰ Hz, 22×10⁻¹⁰-62×10⁻¹⁰ Hz, 64×10⁻¹⁰-69×10⁻¹⁰ Hz), Triplet 3 (0.8×10⁻⁸-2.5×10⁻⁸ Hz, 4×10⁻⁸-11×10⁻⁸ Hz, 12×10⁻⁸-20×10⁻⁸ Hz). Here one period occurs at three years.

(11) Eleventh resonance band: All brain modules connected by superhighway neuron bundles forms a single giant oscillator (10⁻¹³˜10⁻⁹ Hz, gap in order 4); Triplet 1 (8×10₋¹³-15×10⁻¹³ Hz, 17×10⁻³-22×10⁻¹³ Hz, 29×10⁻¹³-46×10⁻¹³ Hz), Triplet 2 (3×10⁻¹¹-9×10⁻¹¹ Hz, 12×10⁻¹¹-22×10⁻¹¹ Hz, 25×10⁻¹¹-40×10⁻¹¹ Hz), Triplet 3 (0.7×10⁻⁹-1.1×10₋⁹ Hz, 1.8×10⁻⁹-3×10⁻⁹ Hz, 3.1×10⁻⁹-5.5×10⁻⁹ Hz). Here, one period is nearly 30 years.

(12) Twelfth resonance band: Entire body sensory network interfacing with the brain as single oscillator, all distributed sensors all around the body integrates with the entire brain just like a single giant oscillator (10⁻¹⁵˜10⁻¹¹ Hz, gap in order 4). Triplet 1 (20×10⁻¹⁵-30×10⁻¹⁵ Hz, 33×10⁻¹⁵-55×10⁻¹⁵ Hz, 59×10⁻¹⁵-76×10⁻¹⁵ Hz), Triplet 2 (0.9×10⁻¹³-11×10⁻¹³ Hz, 15×10⁻¹³-21×10⁻¹³ Hz, 27×10⁻¹³-42×10⁻¹³ Hz), Triplet 3 (0.76×10⁻¹¹-3×10⁻¹¹ Hz, 4×10⁻¹¹-12×10⁻¹¹ Hz, 15×10⁻¹¹-20×10⁻¹¹ Hz). Here one period occurs at three thousand years, it does not mean that it required 3000 years for the changes to be felt, the time gradient is 3000 years. In an atom, further we go outward from a nucleus, separation between energy level decreases, energy decreases, for resonance chain, it is just the opposite.

### CITATION LIST

### Patent Literature

PTL 1: Japanese Patent No. 5187804
PTL 2: US Patent Application Publication No. 2006/0184466
PTL 3: US Patent Application Publication No. 2013/0155516
PTL 4: International Patent Publication No. WO 2007/143327

### Non Patent Literature

NPL 1: http://en.wikipedia.org/wiki/Fractal_antenna
NPL 2: Hohlfeld R, Cohen N (1999). “Self-similarity and the geometric requirements for frequency independence in Antennae”. Fractals 7 (1): 79-84.
NPL 3: Pourahmadazar, J.; Ghobadi, C.; Nourinia, J.; Shirzad, H. (2010). Multiband Ring Fractal Monopole Antennas For Mobile Devices. New York: IEEE. pp. 863 866. doi: 10. 1109/LAWP.2010.2071372.
NPL 4: Shengtong Sun, Shengjie Xu, Weidong Zhang, Peiyi Wu Wei Zhang and Xiulin Zhu Cooperative self-assembly and crystallization into fractal patterns by PNIPAM-based nonlinear multihydrophilic block copolymers under alkaline conditions, Polym. Chem., 2013, Advance Article DOI: 10.1039/C3PY00682D
NPL 5: Meredith M. Murr and Daniel E. Morse, Fractal intermediates in the self-assembly of silicatein filaments, Proceedings of the National Academy of Sciences of the United States of America vol. 102 no. 33 11657-11662 (2005).

1. A fractal computer comprising clocking cavity or dielectric resonators that spontaneously vibrates by harvesting noise at frequencies and phases derived from a pattern calculated from integer series, the pattern being named metric of primes and calculated by trapping integer number of waveforms in the cavity or dielectric resonator (0, 1, 2, 3 . . . ∞) and connecting the solutions of neighboring integers, the metric of prime acting as operator of the fractal computer so that the fractal computer runs by itself:
wherein the solutions for trapping resonating waveforms in the network of cavities or dielectrics are generated in ten different patterns to make ten metric of primes or prime metric: (i) plotting half of the ordered factor of a number vs the integer, and connecting the nearest neighbors in a closed loop; (ii) polar plot of ordered factor of all integers up to a given integer generating clockwise and anticlockwise spirals vs integer; (iii) normalized triangular plot of phase, integer and ordered factor; (iv) 2D plots of ordered factor ≥integer oriented in 12 different planes encompassing 360°; (v) plot of triplet of triplet groups of similar order factor of integers vs integer; (vi) connecting lines of minimum distanced ordered factor points in the ordered factor vs integer plot in a open loop for different limiting integers; (vii) Plot of slopes of maximum ordered factor vs integer; (viii) The empty space created by polar plot of ordered factor connected line make a circular ring at logarithmic distances and as the integer value increases circular rings at filled at regular intervals (ix) plot of combinations of divisors of integers vs integer and (x) Ordered factor normalized to one vs integer;
wherein the prime metric converts a given set of integers into a circuit of clocking cavity or dielectric resonators in the following manners: (i) the pattern provided by a prime metric for a given set of integers is considered as one single clock, the integers are components, clocking cavity or dielectric resonators, and together they generate 360° phase; (ii) ten plots (a) to (j) of prime metric provides details of the structures made by the set of integers: (a) clockwise or anticlockwise rotation; (b) quantized phase used by clocks; (c) triplet type among multiple choices; (d) cavity or dielectric shape; (e) local boundaries; (f) symmetries in time and space in all directions; (g) the components need to be repeated, and the design following which to be repeated; (h) oscillatory and damping relations between different periods of component arrangement; (i) geometry of empty space left vacant by components; and (j) which components make a group that makes a convergent fractal geometric series; (iii) components are arranged side by side and one inside another using the fastest clocking cavity or dielectric resonators in which. assembly of fastest and smallest clocks makes slower clocks, and only one clock makes all clocks in the prime metric based clocking cavity or dielectric resonator hardware;
wherein the assembly of clocking cavity or dielectric resonators or core computer architecture changes the conformation of cavity or dielectric resonators so that they start vibrating following a pattern made of a composition of integers, and the fractal computer builds a unique composition of metric for a given set of integers;
wherein the prime metric hardware made of clocking cavity or dielectric resonators (i) generates self-similar vibrations for the defected or destroyed parts of the hardware where devices or materials used in the fractal computer fill those vibrational frequencies, and it recovers the lost hardware parts; (ii) generates self-similar vibrations to link various discrete groups of frequency patterns which operation of the prime metric hardware replaces the software program. (iii) generates self-similar vibrations to expand, shrink, or filter a set of geometries written in a pattern of frequencies; (iv) generates self-similar vibrations whose pattern of frequencies direct essential changes in rewiring, creating or terminating clocks; (v) generates self-similar vibrations in shorter and longer time domains for any frequency patterns given as input which operation of the prime metric hardware builds higher level perceptions, and regenerates intricate details that never existed in an input; (vi) generates self-similar vibrations using all associated clocks in its hardware reaching longest and the shortest time possible where synchronization starts, stops and decides halting conditions naturally; (vii) generates self-similar vibrations in all associated clocks and no decision is ever rejected; (viii) generates self-similar vibrations in its fractal network of clocks to deliver a decision faster than the clocks using which the query is made; (ix) generates self-similar vibrations in the frequency patterns of morphing geometric shapes only by using a geometric language; and (x) generates self-similar vibrations embedded with new features in an infinite series of integers.
wherein twelve symmetries C2, C3, C5, C7, C11, C13, C17, C19, C23, C29, C31 and C37 are included in designing the fractal computer that cover 99% of all possible patterns that integers up to infinity can produce; and
wherein from C2 to C37, all 12 prime based symmetries unfold in around 10¹¹ (2×3×5×7×11×13×17×19×23×29×3 1×37) number of clocking cavity or dielectric resonators, and for generating a metric hardware larger than this number, entire 10¹ number of oscillators are considered as a single unit and counting of oscillator begins from 1 (1, 2, 3 . . . 10¹¹).

2. The fractal computer according to claim 1:
wherein the prime metric is represented in terms of time crystal which is made of clocking Bloch sphere holding geometric shapes and maps all possible phase relations between all possible resonance frequencies;
wherein an integer represents a given number of events that is clocking geometric shapes, nodes of resonant frequencies, a given number of choices to make decisions, or a given number of points that represents variables; ordered factor of that integer represents the number of points available to construct a geometric shape in the clocking Bloch sphere, while number of combinations of divisors of that integer represents the maximum number of singularity points that can exist in a Bloch sphere of the time crystal;
wherein the singularity points act as corner of geometric shapes, the singularity points bursts energy when system points rotate around the great circle of a Bloch sphere, and the clock remains silent between two singularity points on the circle in which angle made by the length of this section of perimeter is considered as phase in the time crystal;
wherein each singularity point holds a clocking Bloch sphere whose great circle stores a geometric shape made of singularity points in the time crystal; and
wherein new geometric shapes are included as a clocking Bloch sphere inside an empty singularity point or side by side an existing geometric shape in which, for side by side inclusion, the entire assembly of clocking Bloch sphere expands and the assembly of clocking Bloch sphere is time crystal.

3. A fractal computer having clocking cavity or dielectric resonator following the metric of primes comprising:
a sensor module acquiring data from its environment wherein, as the signals fall in, its clocks are activated, wherein it transforms a binary stream of pulses into a 3D network of clocks, and wherein it creates an input time crystal from any given input signal, the time crystals from all sensor modules being combined into one singular time crystal;
an initiator module acting like bipolarity filter, wherein, when a signal passes through one way, it shrinks the size of an input time crystal and its output is a small fractal seed, wherein, if the input is sent through the reverse direction, prime metric fills the missing gaps, thus inflates the time crystal, to its original form, or larger until all input time crystals are integrated as part of a single crystal providing situations that not yet happened, i.e. futuristic dynamics;
a processor module whose all clocks are always active in all its parts, wherein it takes input time crystals from initiator, synchronization begins, wherein entire prime metric from the smallest to the largest time scale synchronizes simultaneously, and wherein all the matching time crystals amplify the signal; and
a regulator module synchronizing with the time crystals missing in the processor part, wherein it activates the new missing clocks inside, wherein the mismatched yet essential clocks find suitable location in the Processor, they being later absorbed there as a part of learning.

4. A computing hardware comprising a clocking cavity or dielectric resonator following the metric of primes for providing an alternative to programming:
wherein clocks holding one or multiple geometric shapes hold an event, and all the shapes activate if any composition of group members are recalled;
wherein resonant vibrations link missing parts of prime metric in the hardware, which enables simulating events in past and future where no information is available, and prime metric driven linking of missing patterns negates the need for programming;
wherein the computing hardware uses power only to manage re-wiring, but decision making does not require power consumption in principle, as there is no reduction, no collapse, and no junction, where the computing hardware runs always as it evolves its wiring by itself for learning, a computation never stops, and Halt is set by observer's time resolution;
wherein the computing hardware never performs a search, but components reply spontaneously, namely search without searching, the computing hardware never acquires a true input, but it has all possible input elements already stored inside as basic geometric shapes as part of the geometric musical language (GML), and thus it reads them outside, thenceforth, a spontaneous reply is its operational key;
wherein the prime metric hardware uses only one element, clock, considers only parameter phase, then using that emulate mass, space and time to process information making decisions, learning and thus changing the wiring of clocks,
whereby the computing hardware explores singularity unlike classical or quantum computing, and shrinks massive information into a small geometric clocking seed without involving any wiring, and a wireless connection to process geometry at all the time scales is allowed in the hardware simultaneously.

5. The fractal computer according to claim 3:
wherein different drives run the hardware of clocking cavity or dielectric resonators as a part of primary driving of morphing;
wherein morphing is synchronization of clocks in a triangular clock network (System-User-Environment, SUE) where the morphing encodes the time crystal assembly in S such a manner that the dynamic of S holds specific parts of U and E that takes part in synchronization, S tries to absorb U and E rhythms, if the discrepancies are sorted out by integrating rhythms, and S sends suitable clocks to U and E to manipulate them;
wherein five sub-drives (i)-(v) run to execute a morphing drive: (i) unitary drive in which diameter of clock is auto-adjusted; (ii) C2 Symmetry drive in which phase transition of Bloch sphere network to generate symmetry; (iii) Fractal clock drive in which system point moves to the fastest clock and then to the slowest and does back and forth; (iv) synchronization drive that triggers self-assembly and dis-assembly of clocks; and (v) protection drive in which long term memory protects the core of S and short-term memory enables editing;
wherein information or network of phase in a time crystal is processed simultaneously everywhere in the network which includes the questioner/observer,
whereby clocks residing side by side and above-and-within operates together, hence no data transmission or communication occurs, no choices are rejected, yet in course of computing the computer matches the dynamics of morphing matrix, MBS or S with that of the observer, U and the nature, E.

6. The fractal computer according to claim 3:
wherein the fractal computer comprises clocking cavity or dielectric resonator following a fractal information theory;
wherein every single cell of a Turing tape contains a Turing tape inside and the tape is a Fractal tape where the Turing machines self-assemble side by side and one inside another;
wherein information is written in the topology of phase space of the Fractal machine, the machine is defined with four tuples where the machine (i) converts and absorbs clocks, (ii) expands to find associations, (iii) transforms to integrate, and (iv) replies and edits to learn these four steps are taken together, repeated indefinitely, and the computation never stops;
wherein the total number of cycles participating in synchronization is P and observer synchronizes with S number of loops where the product of density of loops and the time bandwidth for P is DenP and the same for S is DenS, the ratio −DenP/DenS being the information entropy of communication channel; and
wherein the starting phase difference between the two circles controls the output rhythm, hence, by absorbing output, other nested rhythms get these two information, D1/D2=V2/V1, ratio of diameter determining relative angular speed.

7. The computing hardware according to claim 4:
wherein the clocking cavity or dielectric resonator has a rapidly vibrating boundary with a porous membrane where from the resonating carriers leak;
wherein the clocking cavity or dielectric resonator converts white thermal, electrical, magnetic, electromagnetic, mechanical noises into quantized energy sources;
wherein the clocking cavity or dielectric resonator absorbs at specific resonance frequencies, a group of the clocking cavity or dielectric resonators build slower clocks, these slower clocks resonate at their own distinct frequencies and using a membrane or cover it screens unwanted transmissions if necessary;
wherein the speed of the system point rotating in a clock of the cavity or dielectric resonator is determined by time width of singularity domain or guest clock diameter, while its host clocks diameter is fixed and time taken by the system point to cross the diameter of a guest clock is the unit of speed,
wherein a waveform is a periodic oscillation, represented by a single system point rotating around a circle where, if a new guest clock sits on this host circle with its own system point, then together they constitute a beating, and similarly if more clocks are added, classical beating gets more nested guest clocks, where time crystals of the cavity or dielectric resonator gets more Bloch spheres and if the clock oscillates its diameter between zero and maximum, then it makes quantum beating, and if more than three such oscillatory cycles engage in beating, then it makes fractal beating which creates a new clock with a new system point; and
wherein uncertainty is added to clocking via: (i) nesting of Hilbert spaces, generating a fractal beating; (ii) an observer sees a single triangle on a sphere from infinite angular positions; (iii) smaller the mass larger the diameter of clocks, so any point could be a superposition of more than two such clocks; and (iv) diameters of the clocks may oscillate as a function of time.

8. The computing hardware according to claim 4:
wherein time crystals are self-assembled following ten rules and ten conditions that trigger self-assembly;
wherein, time crystals (i) transform by phase transition and symmetry breaking; (ii) create, destroy clocks generating new shorter routes; (iii) copy paste unknown clocks; (iv) reorient and rewrite geometric information in existing clocks; (v) C2 symmetry drive; (vi) morph to mimic evolutionary dynamics of environment; (vii) protection drive: Long term and short-term memory; (viii) rule of clock integration extracted; (ix) expands to keep morphology intact; and (x) rule of evolution follow the mathematics of ordered factor;
wherein the ten conditions that triggers self-assembly of clocks are: (i) time cycles bond only under a certain specific condition; (ii) matching the difference in the density of time cycles turn perpetual; (iii) the geometric information encoding process is identical to the density matching process; (iv) without cross check there is no abrupt formation of a new time cycle; (v) fusion and fission of the tiny time cycles; (vi) matching the spin direction for the time cycles; (vii) phase synchronization run in parallel to the geometric synchronization; (viii) creating a mirror image from the phase space hierarchical network by fractal route; (ix) time cycle network expands and continuously try to produce longer than the longest time cycles; and (x) prime frequency wheel drive.
